(19) United States
(12) Patent Application Publication
(10) Pub. No.: US 2020/0160229 A1
(43) Pub. Date: May 21, 2020

(54) Creating User Experiences with Behavioral Information and Machine Learning

(71) Applicant: Adobe Inc., San Jose, CA (US)

(72) Inventor: Edmund Francis Anthony Atcheson, Wandsworth (GB)

(73) Assignee: Adobe Inc., San Jose, CA (US)

(21) Appl. No.: 16/192,164

(22) Filed: Nov. 15, 2018

(51) Int. Cl. G06N 99/00; G06N 5/02

(52) U.S. Cl. CPC G06N 99/005; G06Q 30/0641; G06N 5/02

(57) ABSTRACT

Automatic user experience generation is described. A user experience system receives input specifying at least one machine learning model to use in generating a user experience for at least one specified user profile. Available machine learning models are identified and displayed for selection by the system based on profile information associated with the user profile(s). An output is generated by applying at least a subset of the profile information as input to the selected machine learning model, and supplies the generated output to at least one different machine learning model, to generate a target outcome for the selected user profile(s). Additionally, the system automatically detects acceptable data input types and formats for a model and translates data as necessary before input to the model(s). Model outputs are then used by an experience generation module to identify digital content corresponding to the outputs and generate user experiences including the digital content.

### BACKGROUND

Service provider systems continue to make advances in computing technologies to enable creation of digital content, which is often combined with different digital content to generate a user experience for the service provider, with the goal of captivating user interest. Conventional approaches for creating user experiences thus focus on incorporating digital content that appeals to as many users as possible, such as incorporating digital content pertaining to current pop culture, survey responses, or other criterion that generally identify what is likely to appeal to a given demographic population. To reduce manual guesswork involved with identifying digital content to include in a user experience, some conventional approaches employ machine learning models to identify digital content. An e-commerce platform, for instance, may train a machine learning model on customer data to identify shopping trends and display advertisements that reflect the identified shopping trends.

Conventional user experience creation systems, however, are restricted to using a single machine learning model and a single data set upon which the machine learning model was trained. Furthermore, generating reliable outputs using these conventional systems often requires manual input by experienced data scientists familiar with how the single machine learning model was trained, what specific type of output is generated by the single machine learning model, and so forth. Thus, conventional user experience creation systems operate as a black box, without any indication as to how inputs are processed or what processing is being performed, providing no indication as to the reliability of an output being an accurate representation of digital content that is likely of interest for inclusion in a user experience. Consequently, users avoid using conventionally configured systems to generate user experiences due to their limited scope and obfuscated steps used in generating an output. Additionally, conventionally configured systems are unable to identify multiple machine learning models that may be used in combination to generate a desired outcome, and are unable to improve subsequent performance by monitoring user interaction with a generated output. Thus, conventional approaches for generating user experiences often fail to accurately target individual users intended to be captivated by the user experience.

### SUMMARY

To overcome these problems, automatic user experience generation is described. A user experience system receives an indication of one or more user profiles for which a user experience is to be generated. Responsive to this selection, the user experience system ascertains profile information associated with the selected user profile(s) and identifies at least one machine learning model that is useable to generate an output given the identified profile information. The identified machine learning models are then output for display in a user interface along with a prompt to select a machine learning model for use in generating the user experience. In some implementations, the machine learning model is identified in the user interface by a description of a target outcome generated by the model, such as a likely vacation destination for the user profile(s), a make and model of car likely to be purchased by the user profile(s), and so forth. After generating an output by applying the profile information to the selected machine learning model, the user experience system may further process the output using one or more different machine learning models and optionally one or more different data sources describing information not included in the profile information, in order to generate a customized user experience for the selected user profile(s).

To accommodate for different machine learning models that may operate using different types and formats of input and output data, the user experience system employs a data translation module that ensures input data is of an appropriate type and format before being applied to a machine learning model. Thus, the user experience system is configured to generate outputs using disparate models and data sources, leveraging different data sets in generating a user experience. The machine learning model outputs are then provided to an experience generation module that identifies digital content corresponding to information included in the outputs and generates a user experience including the identified digital content. Subsequent interaction by the user profile(s) with the generated user experience can then be monitored by the user experience system and provided as feedback to the machine learning models to re-train and improve the user experience system's accuracy in generating user experiences over time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ user experience creation techniques described herein.

FIG. 2 illustrates an example implementation in which a user experience system of FIG. 1 generates a user experience using behavioral information and machine learning.

FIG. 3 illustrates features of the user experience system implementing a machine learning model to perform image classification in accordance with one or more implementations.

FIG. 4 illustrates an example user interface for the user experience system in accordance with one or more implementations.

FIG. 5 further illustrates an example user interface for the user experience system in accordance with one or more implementations.

FIG. 6 further illustrates an example user interface for the user experience system in accordance with one or more implementations.

FIG. 7 further illustrates an example user interface for the user experience system in accordance with one or more implementations.

FIG. 8 further illustrates an example user interface for the user experience system in accordance with one or more implementations.

FIG. 9 further illustrates an example user interface for the user experience system in accordance with one or more implementations.

FIG. 10 further illustrates an example user interface for the user experience system in accordance with one or more implementations.

FIG. 11 further illustrates an example user interface for the user experience system in accordance with one or more implementations.

FIG. 12 further illustrates an example user interface for the user experience system in accordance with one or more implementations.

FIG. 13 further illustrates an example user interface for the user experience system in accordance with one or more implementations.

FIG. 14 further illustrates an example user interface for the user experience system in accordance with one or more implementations.

FIG. 15 further illustrates an example user interface for the user experience system in accordance with one or more implementations.

FIG. 16 further illustrates an example user interface for the user experience system in accordance with one or more implementations.

FIG. 17 further illustrates an example user interface for the user experience system in accordance with one or more implementations.

FIG. 18 further illustrates an example user interface for the user experience system in accordance with one or more implementations.

FIG. 19 further illustrates an example user interface for the user experience system in accordance with one or more implementations.

FIG. 20 further illustrates an example user interface for the user experience system in accordance with one or more implementations.

FIG. 21 further illustrates an example user interface for the user experience system in accordance with one or more implementations.

FIG. 22 is a flow diagram depicting a procedure in an example implementation for generating a target outcome using multiple machine learning models using the user experience creation techniques described herein.

FIG. 23 is a flow diagram depicting a procedure in an example implementation for generating a custom user experience using outcome values generated by multiple machine learning models using the user experience system described herein.

FIG. 24 illustrates an example system including various components of an example device that can be implemented as any type of computing device as described and/or utilized with reference to FIGS. 1-23 to implement embodiments of the techniques described herein.

### DETAILED DESCRIPTION

Overview

As a result of advances in digital content creation technologies, computing systems are used as a primary tool for content designers in creating user experiences comprised of digital content. These computing systems enable creation of diverse user experiences including a wide range of different digital content, which can add meaning and context to the user experience that is personal in nature to the particular user viewing the digital content. Conventional computing systems attempt to generate user experiences that will appeal to the widest range of users, such that a given user experience will be more likely to captivate the attention of as many users as possible. To do so, these conventional systems rely on machine learning models to provide an indication as to digital content that is likely of interest to a given population. An e-commerce platform, for instance, may design a machine learning model configured to analyze data describing purchase histories associated with user accounts registered with the platform and output information describing purchase trends of the registered user accounts. Such conventional approaches then generate user experiences including digital content reflecting purchase trends for a majority of the registered user accounts, and fail to account for the profile information of individual user accounts, resulting in user experiences that do not captivate a significant portion of the overall user accounts.

The machine learning models implemented by these conventional systems are further limited in that they are applicable only to input data of a same type, format, and data distribution as the input data upon which the machine learning model was trained. The example e-commerce machine learning model, for instance, is limited to generating an output based on input data that is of a same format and type as data included in the registered user accounts used to train the example machine learning model. This prohibits conventional systems from generating a user experience based on outputs obtained from two or more different machine learning models trained on different data sources with different data formats. Likewise, these deficiencies prevented conventional systems from incorporating additional data sets beyond that used to initially train the machine learning model for purposes of re-training the model, supplementing existing user profile information with external data, and so forth. Furthermore, the machine learning models implemented by these conventional systems are not accompanied by information describing an acceptable type and format of input data useable by the machine learning model to generate an output, nor are they accompanied by information describing a type of output generated by the particular machine learning model.

As such, conventional systems require data scientists familiar with operation of the individual machine learning models to either manually input data in order to generate an accurate output or use a program to translate the data into the correct format. The distribution of data applied to the machine learning model also has to be similar in order for the machine learning model to function properly. For instance, if the model has been trained on data that has a certain pattern, applying different data having a different pattern will result in the machine learning model generating an output having a relatively lower accuracy. In order to generate relatively accurate results, conventional systems require a data scientist to manually test a machine learning model with a data set to be processed by the machine learning model, such as to determine if the data distribution is similar, if the model is over-fit, and so forth. After this testing, the data scientist is required to manually tune the structure of the model based on desired outputs, such as by altering the strength of a penalty used in regularized regression, alter a number of trees to include in a random forest, and so forth.

In order for conventional systems to use the output of a trained machine learning model as input to a different machine learning model, a data scientist is required to take the output, translate it into a format that is compatible with the different machine learning model, and combine the translated output with a unique identifier for the different machine learning model. The data scientist will also need to determine how the “run” of data applied to a machine learning model will be performed, such as in a full batch, in a mini batch, in near-real time, and the like, to ensure the correct data operations are in place.

Additionally, conventional systems frequently cause the outputs of a given machine learning model to degrade and deliver increasingly inaccurate outputs. To mitigate this degradation, conventional systems copy data input to, and output from, a given machine learning model. When enough data is amassed, conventional systems re-train the given machine learning model with the copied data, then evaluate the retrained machine learning model against its previous state, selecting one of the machine learning models for use in processing additional data. However, conventional systems are unable to account for combinations of different data types, such as behavioral analytics data combined with sales data, which limits re-training a given machine learning model to a specific data type, format, and distribution. As a result, outputs generated by these conventional systems fail to account for external variables that cannot be defined within a given machine learning model's useable data scheme, and thus generate relatively inaccurate outputs.

Conventional systems are thus prone to user-error mistakes, and are unintuitive to individuals unfamiliar with the particular processing steps performed by a machine learning model.

Accordingly, automated user experience generation techniques and systems are described. In one example, a user experience system provides a user interface for generating a user experience, including a prompt to specify at least one user profile for which the user experience is to be generated. In response to receiving a selection of the at least one user profile, the user experience system determines profile information associated with the at least one user profile. Using the profile information, the user experience system identifies at least one machine learning model that is useable to generate an output given the data included in the profile information, even if the data included in the profile information is of a different format or type than that useable as input by the identified machine learning model(s). The identified machine learning models are then presented in the user interface for selection to be used in generating the user experience. In some implementations, the user experience system displays the identified machine learning models by model type, and alternatively or additionally based on a type of outcome that will be generated by each identified machine learning model. In this manner, the user experience system provides a comprehensive description of what data will be output by a given machine learning model using profile information of the at least one selected user profile as input data. This enables even inexperienced users, not simply data scientists that designed the particular model, to understand how particular digital content is identified for inclusion in the user experience.

Upon receiving a selection of a machine learning model to use in processing the profile information, the user experience system generates a first output by applying the profile information as input to the selected machine learning model. The first output may then be supplied by the user experience system to a different machine learning model to generate a second output, and the process may be repeated for as many different machine learning models as selected by a user of the system. To accommodate for differences among various machine learning models, the user experience system employs a data translation module that is configured to automatically determine a type and format of input data useable by a machine learning model and translate the profile information, previous machine learning model output, or combinations thereof, prior to supplying the data as input to a selected machine learning model. This enables the user experience system to generate a user experience using disparate machine learning models that generate different types and formats of output data, different machine learning models designed by different data scientists, and so forth. Using the data translation module, the user experience system is further configured to train or re-train a machine learning model using a data source different from a data source used to originally train the machine learning model, thereby extending the scope of a given machine learning model beyond its originally intended scope.

Given the outputs generated by the combination of selected machine learning models, the user experience system employs an experience generation module that is configured to identify digital content based on information included in the outputs and generate the user experience to include the digital content. The user experience system is further configured to continuously improve the accuracy of various machine learning models used to generate the user experience by monitoring behavior information of the selected user profiles with respect to the generated user experience. For instance, monitored user profile interaction with the user experience can be provided as feedback to one or more of the selected models in a reinforced learning manner, such as to indicate that the generated user experience was accurate or inaccurate. Through this reinforced learning, the user experience system continuously improves a degree of accuracy with which customized user experiences are generated.

Thus, the described techniques provide advantages not enabled by conventional systems by automatically identifying available machine learning models and outcomes that can be generated by the identified models for a selected user profile, identifying multiple different machine learning models that can be used in combination to generate a desired outcome, and automatically translating data in a manner that is useable by the different machine learning models to generate accurate outputs. The described system and techniques additionally enable even inexperienced to specify with particularity how digital content is identified for inclusion in a customized user experience by presenting an intuitive user interface that clearly describes each step taken in generating the user experience, providing controls for adjusting tunable parameters of the individual machine learning models, and automatically identifying combinations of machine learning models that may be used to generate a desired outcome, even when the identified machine learning models themselves do not include an indication of being usable with another machine learning model. Other examples are also contemplated, further discussion of which may be found in the following sections and shown in corresponding figures.

Term Descriptions

As used herein, the term “machine learning model” refers to a model that utilizes algorithms to learn from, and make predictions on, known data by analyzing the known data to learn and generate outputs that reflect patterns and attributes of the known data. Machine learning models thus include, but are not limited to, decision trees, support vector machines, linear regressions, logistic regressions, Bayesian networks, random forest learning, dimensionally reduction algorithms, boosting algorithms, artificial neural networks, deep learning systems, and so forth. In this manner, a machine learning model is configured to make high-level abstractions in data by generating data-driven outputs in the form of predictions or decisions from known input data.

As used herein, the term “profile information” refers to data describing characteristics of an individual user, or group of multiple users, that are identifiable by a user profile. For instance, the profile information may specify a home address of the user, a product currently owned by a user, a product ordered online, a product ordered offline, personal likes and dislikes of the user, and so forth. In some implementations, the profile information for a given user profile excludes any personally identifying information that is particular to an individual user or group of users, such as a social security number, a phone number, a name, a home address, and the like, such that the techniques described herein can be performed without compromising or otherwise revealing a user's confidential information.

As used herein, the term “behavior information” refers to data describing a user profile's viewing of, or interactions with, an output generated by one or more machine learning models using the techniques described herein. In this manner, behavior information may include any type of monitored activity with respect to a user experience generated using the machine learning model systems and techniques described herein, and may be dependent on a type of the user experience. For instance, in an example scenario where the user experience includes a travel recommendation, behavior information may include a geolocation associated with a user profile, such as physical presence at a travel agency, proximity to a physical beacon at the location of the travel recommendation, and so forth. As another example, behavior information may include monitored online activity, such as time spent at a travel website, types of photographs viewed online, products ordered, and the like. Thus, behavior information includes any type of data that characterizes a user profile's behavior with respect to a user experience and information that is useable to improve an accuracy of at least one machine learning model used to generate the user experience.

As used herein, the term “user experience” includes a collection of one or more pieces of digital content that is curated and organized for display for at least one user profile using the machine learning model system and techniques described herein. Digital content included in a user experience may be any suitable type of digital content, such as an image, a video, text, audio, combinations thereof, and so forth. For example, in a scenario where a user experience is generated to appeal to likely vacation destination interests for a specified user profile, where the specified user profile is determined to be likely interested in a vacation to Hawaii, the user experience may include one or more images of Hawaiian beaches, audio of waves crashing on the beach, text describing an available Hawaiian vacation package, and so forth. The user experience may then be displayed as a travel website's home page, a banner inserted in a different web page, an electronic billboard, an email, a notification, combinations thereof, and so forth.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

Example Environment

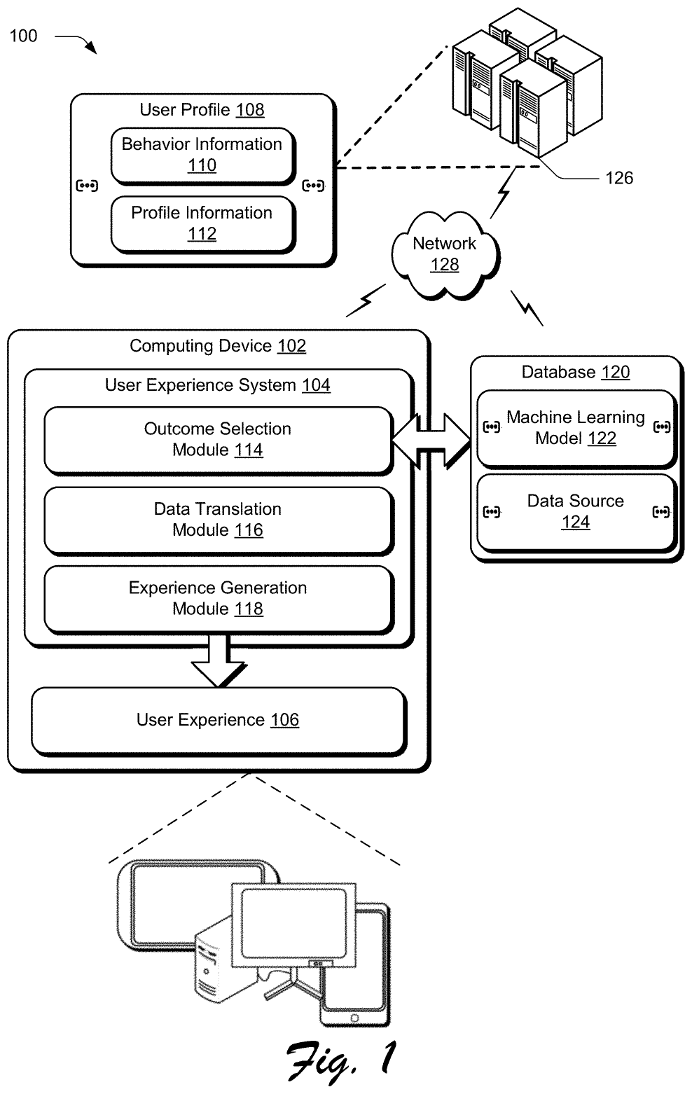

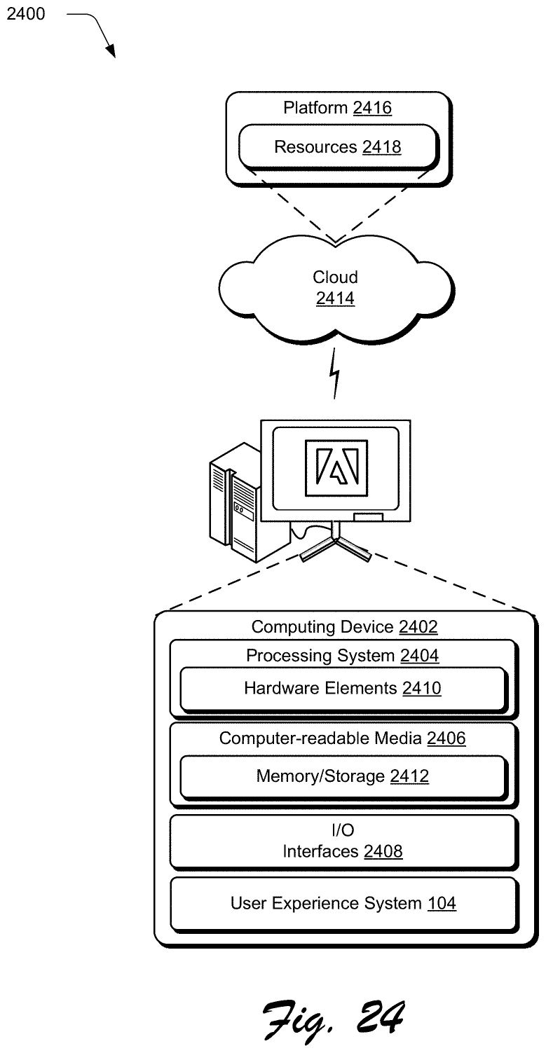

FIG. 1 is an illustration of a digital medium environment 100 in an example implementation that is operable to employ techniques described herein. The illustrated environment 100 includes a computing device 102, which may be configured in a variety of manners. The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as described with respect to FIG. 24.

The computing device 102 is illustrated as including user experience system 104. The user experience system 104 represents functionality of the computing device 102 to create a user experience 106 for at least one user profile 108, based on behavior information 110 and profile information 112 of the user profile 108. By way of example, the user experience system 104 includes functionality to specify digital content to be included in the user experience 106. As described herein, the user profile information 112 may include information describing characteristics of an individual user to whom the user profile 108 corresponds. For instance, the profile information 112 may specify a home address of the user, a product currently owned by a user, a product ordered online, a product ordered offline, personal likes and dislikes of the user, and so forth. As described herein, the behavior information 110 refers to information that is useable to characterize the individual user's behavior with respect to the user experience 106, in order to provide feedback to the user experience system 104 and refine future user experiences generated by the system, as described in further detail below. The behavior information 110 may include any suitable type of monitored activity with respect to the user experience 106, and is thus dependent on the type of user experience 106 generated.

For instance, in a scenario where the user experience 106 includes a travel recommendation, the behavior information 110 may include a geolocation associated with a user profile, such as a geolocation determined by a user's proximity to a physical beacon, a geolocation determined by a user's mobile device settings, and so forth. In a similar manner, a time spent on a travel website may be included in the behavior information 110 and used as feedback to indicate an accuracy of the travel recommendation user experience 106. In another example, when the user experience 106 includes a product recommendation that is likely of interest to one or more user profiles 108, the behavior information 110 may include an indication that the product was subsequently ordered online or offline, which may be used as positive feedback, while behavior information 110 indicating that the product was deleted from an online shopping cart may be used as negative feedback. Thus, the behavior information 110 includes any suitable information that describes a user's perception of, or reaction to, a user experience.

Although described with context to a single user profile 108, the user experience system 104 is configured to generate a user experience 106 for any number of user profiles 108, such as to generate a user experience for a designated group of users, or for a group of users sharing common characteristics as indicated by their respective profile information 112. For instance, a group of users may be identified based on profile information describing their respective household sizes, such that a user experience 106 is generated for a group of users sharing a particular household size, in a manner that also accounts for differences in the respective profile information 112 of the disparate users in the group. After receiving a selection of at least one user profile 108 for which the user experience 106 is to be generated, the user experience system 104 analyzes the profile information 112 of the selected profiles to determine what data is available as a basis for generating the user experience 106.

To accommodate for the wide range of different types of data that may be included in any one of the user profiles 108, the user experience system 104 employs an outcome selection module 114, the data translation module 116, and the user experience generation module 118. The outcome selection module 114, the data translation module 116, and the user experience generation module 118 are implemented at least partially in hardware of the computing device 102 (e.g., through use of a processing system and computer-readable storage media), as described in further detail below with respect to FIG. 24.

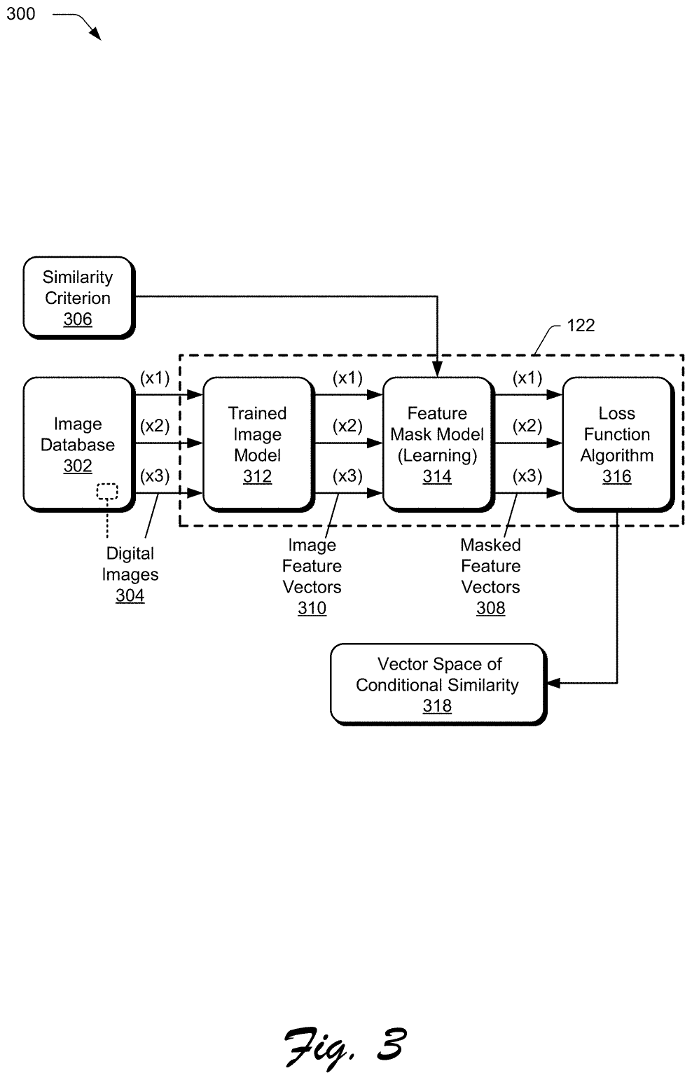

To generate the user experience 106, the outcome selection module 114 analyzes the profile information 112 of the one or more selected user profiles 108 to determine what data is included in the profile information. Based on the available data included in the profile information 112, the outcome selection module 114 is configured to communicate with a database storing machine learning models, such as data base 120, and identify one or more machine learning models 122 that are useable to generate an output given the data included in the profile information 112. The database 120 may be implemented locally in storage of the computing device 102 or may be implemented in a storage location remote from the computing device 102. As described herein, each of the machine learning models 122 refers to a model that utilizes algorithms to learn from, and make predictions on, known data by analyzing the known data to learn and generate outputs that reflect patterns and attributes of the known data. The machine learning models 122 thus include, but are not limited to, decision trees, support vector machines, linear regressions, logistic regressions, Bayesian networks, random forest learning, dimensionally reduction algorithms, boosting algorithms, artificial neural networks, deep learning systems, and so forth. In this manner, a machine learning model 122 is configured to make high-level abstractions in data by generating data-driven outputs in the form of predictions or decisions from known input data, such as the profile information 112. Each machine learning model 122 may be associated with a respective data source 124 that is used to train the machine learning model 122, as described in further detail below with respect to FIG. 3. Thus, the outcome selection module 114 is configured to identify a specific type and format of input data upon which a machine learning model was trained and is similarly configured to determine acceptable types of inputs for a given machine learning model that are useable by the model to generate an accurate output.

Because respective outputs generated by each of the machine learning models 122 depend heavily on the format and data type provided as inputs, the user experience system 104 implements the data translation module 118 to ensure that any profile information 112 provided to a machine learning model 122, or a machine learning model's output provided as input to a different machine learning model, is of a format and type that is compatible with the machine learning model 122. For instance, consider an example scenario where a machine learning model 122 is configured to generate an output predicting a likely vacation destination for a user given the user's date of birth and country of residence as inputs, where the date of birth is input in a DD-MM-YYYY format, and the country of residence is input in a plain text description in the English language. In a scenario where the profile information 112 describes a user living in England having a birthdate of 26 Jan. 1965, such profile information can be provided as input to the machine learning model without first translating the data.

Conversely, profile information describing a user living in Hrvatska with a birthdate of Jun. 16, 1988 would not be useable by the example machine learning model and may result in an output that does not accurately reflect a likely vacation destination for the user. Thus, the translation module 118 is configured to identify an appropriate data type and format for input to a machine learning model, and in the example scenario would translate the user profile information to indicate a user living in Croatia with a birthdate of 16 Jun. 1988, such that the machine learning model could generate an accurate output predicting a likely vacation destination for the user profile. In addition to translating existing data included in the profile information 112, the data translation module 116 may generate new data for inclusion in the profile information 112, which may be generated from existing profile information. For instance, a user profile 108 including profile information 112 describing a user's geolocation in Ontario may be updated by the data translation module 116 to specify that a country associated with the user profile 108 as Canada, which is representative of a new data segment not previously identified by or included in the profile information 112.

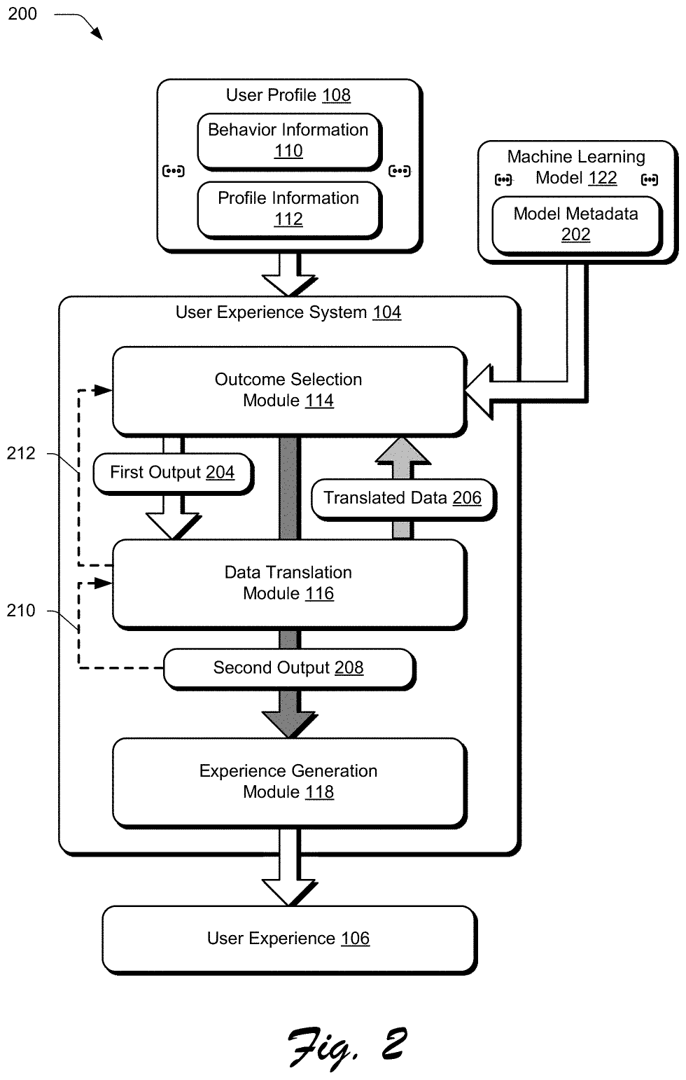

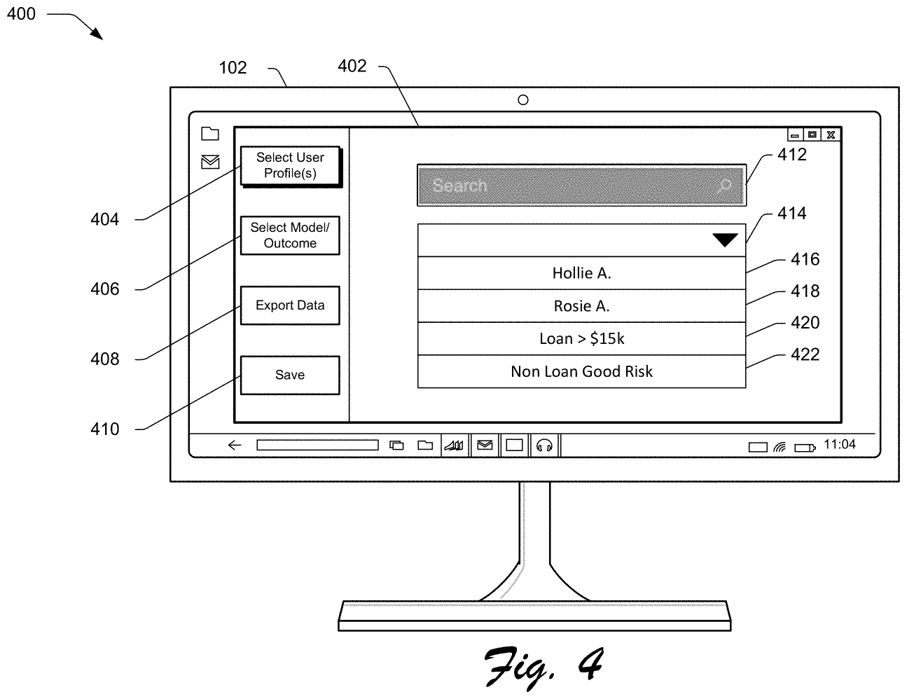

The user experience system 104 is configured to identify appropriate input data types and formats for a given machine learning model 122 using information gleaned from the data source 124 used to train the model. Alternatively or additionally, the user experience system 104 may identify the appropriate input data type and format for a machine learning model 122 based on metadata of the machine learning model, as described in further detail below with respect to FIG. 2. Thus, the user experience system 104 can readily identify available machine learning models 122 useable to generate an output for specified profile information 112, even in a scenario where the profile information 112 is unable to be directly applied to the machine learning model 122 without prior translation or modification. As described and illustrated below with respect to FIGS. 4-21, the identified machine learning models 122 can be displayed to inform a user of a computing device implementing the user experience system 104 of available models useable to generate the user experience 106, even in a situation where the identified models may not be able to generate an output given unmodified profile information 112.

After the profile information 112 is processed by one or more of the machine learning models 122, and optionally after a machine learning model output is processed by a different one of the machine learning models 122, as described in further detail below with respect to FIG. 2, the experience generation module 118 generates the user experience 106. To do so, the user experience system 104 communicates at least one machine learning model output to the experience generation module 118, where the output includes information identifying at least one piece of digital content to be included in the user experience 106. The digital content to be included in the user experience 106 may be any suitable type of digital content, such as an image, a video, text, audio, combinations thereof, and so forth. For instance, in an example scenario where machine learning outputs generated by the user experience system 104 indicate that a user profile 108 is likely to be interested in a vacation to Hawaii, the experience generation module 118 may retrieve one or more images of Hawaiian beaches, audio of waves crashing on the beach, and text describing an available Hawaiian vacation package, and incorporate the retrieved content into a user experience 106 that may be displayed, for example, on a home page of a travel website when the user profile 108 navigates to the travel website's home page.

The experience generation module 118 is configured to retrieve digital content to include in the user experience 106 from one or more data storage locations, such as from a local storage location of the computing device 102, as described in further detail below with respect to FIG. 24, or from a remote data storage location, such as from one of the data sources 124. The user experience system 104 is further configured to access at least one storage location 126 implemented remotely from the computing device 102, such as via the network 128. In this manner, the user experience system 104 may access information describing user profiles 108 from a multitude of different storage locations 126 to generate user experiences 106 for a wide range of users, leveraging diverse sets of profile information. Because each of the machine learning models 122 benefits from additional training data that may be obtained, for instance, from remote storage locations 126 and the database 120, the techniques described herein are further useable to continually train and improve individual ones of the machine learning models 122 to generate user experiences 106 that more accurately target and reflect interests of the respective user profiles 108. Operation of the outcome selection module 114, the data translation module 116, and the experience generation module 118 is described in further detail below.

User Experience Generation

FIG. 2 depicts a system 200 in an example implementation showing operation of the user experience system 104 of FIG. 1 in greater detail as generating a user experience 106, given behavior information 110 and profile information 112 of at least one user profile 108, and multiple machine learning models 122. Using the techniques described herein, the user experience 106 is generated using at least one of the machine learning models 122 in a manner that personalizes the user experience 106 for a specified one or more of the user profiles 108, given their respective profile information 112. The techniques described herein further enables for reinforced learning to re-train the machine learning models 122 over time, using behavior information 110 describing the specified user profile(s) 108 interaction with the user experience 106.

In the illustrated example, the outcome selection module 114 receives an indication of at least one user profile 108 for which the user experience 106 is to be generated, along with profile information 112 for the at least one user profile 108. Using the profile information 112, the outcome selection module is configured to identify at least one machine learning module 122 that is useable to generate an output given the profile information 112. In some implementations, the outcome selection module 114 identifies a useable machine learning model 122 for the profile information 112 based on model metadata 202 embedded in the machine learning model 122. The model metadata 202, for instance, may specify an input data set used to train the machine learning model 122, a data type of input to be received by the model, a format of the input to be received by the model, one or more outputs generated by the machine learning model, a description of the model, and so forth. The model metadata 202 may be specified by a designer of the machine learning model 122, may be specified by a user of the computing device implementing the user experience system 104, and so forth. Alternatively, the outcome selection model 114 may automatically determine model metadata 202 independent of any manual user input, such as by analyzing a data source 124 upon which the machine learning model 122 was initially trained, as illustrated in FIG. 1.

The outcome selection module 114 may then display the one or more identified machine learning models 122 in a user interface of the computing device implementing the user experience system 104. In this manner, the outcome selection module 114 conveys to a user what machine learning models are available to process the profile information 112 and generate an output useable to generate the user experience 106. In some implementations, the outcome selection module 114 may identify a data type and format of an output generated by the machine learning model 122 and describe the machine learning model's output in terms of an outcome produced by the model. For instance, for a propensity machine learning model 122 that is otherwise only identified by the model metadata 202 as a propensity model, the outcome selection module 114 may determine that the example machine learning model generates an output that describes a make and model car that a user is most likely to purchase. Thus, in addition to listing the machine learning model 122 in the user interface as an available propensity model to process the profile information 112, the outcome selection module 114 may additionally present a plain text description of the outcome generated by the model, such as a “Type of Purchase (Car)” description. In this manner, the outcome selection module 114 clearly describes what output will be generated by a machine learning model, thereby enabling even inexperienced users who have no prior dealing with a machine learning model to intuitively understand a resulting outcome of applying the profile information 112 to the particular model. This is particularly useful in differentiating among different types of machine learning models that generate different outcomes using identical types of input data.

Upon receiving a selection of an available machine learning model or target outcome, the outcome selection module retrieves a corresponding machine learning model 122. In some implementations, the outcome selection module 114 may receive a selection of an outcome that corresponds to a machine learning model configured to generate an output using information included in the profile information 112 and additional information not included in the profile information 112. For instance, in response to receiving a selection of a target outcome of identifying a likely vacation destination for the user profile 108, the outcome selection module 114 may identify a machine learning model 122 that outputs a likely vacation destination given input data describing a user's age, geographic location, and hobbies of interest. In an example scenario where the profile information 112 for the selected user profile 108 includes data describing only the user's age and geographic location, the identified machine learning model 122 would require additional information describing hobbies of interest for the user corresponding to the user profile 108. In such a scenario, the outcome selection module 114 is configured to identify that additional information not included in the profile information 112 is necessary to generate an accurate output using the identified model and may search for an additional machine learning model that is useable to predict likely hobbies of interest given input data describing a user's age and geographic location. Thus, the outcome selection module 114 is configured to identify combinations of two or more machine learning models that may be used together to generate a desired output, thereby leveraging a range of different machine learning models to generate an output that otherwise could not be generated given the available profile information 112 and a single machine learning model 122.

The profile information 112 is then applied to the identified machine learning model(s) 122 to generate the first output 204. The first output 204 is then communicated to the data translation module 116 along with an indication of one or more different machine learning models 122 for which the first output 204 is to be supplied as input for generating the user experience 106. The outcome selection module 114 communicates the indication of the one or more different machine learning models to the data translation module 116 along with their respective model metadata 202 to inform the data translation module 116 of a data type and format to be supplied to the different machine learning models. In response to determining that the first output 204 is of a different data type or format than a data type or format to be input to one of the different machine learning models, the data translation module 116 is configured to generate translated data 206 from the first output 204. The translated data 206 is then communicated to the outcome selection module 114 for use as input data to a subsequent one of the machine learning models 122. The outcome selection module 114 then generates the second output 208 using the translated data 206, the subsequent machine learning model 122, and optionally profile information 112. This process of generating outputs from the machine learning models, translating data into a format and type suitable for input to a different machine learning model, and generating additional outputs using the different machine learning model may be repeated for as many iterations as necessary to generate the user experience 106, as indicated by the arrows 210 and 212. Using the techniques described herein, the outcome selection module 114 is configured to generate n outputs using m machine learning models 122, where m and n each represent any positive integer. For purposes of simplicity, however, FIG. 2 is illustrated as generating user experience 106 using only first output 204 and second output 208.

Provided the second output 208, the experience generation module 118 identifies at least one piece of digital content that represents information included in the second output 208 and includes the piece of digital content in the user experience 106. In this manner, the user experience system 104 is configured to generate customized user experiences that are tailored specifically for the profile information 112 of one or more specified user profiles 108. Though the use of multiple machine learning models 122, the user experience 106 is generated based on analyzed data from one or more different data sources used to train the respective machine learning models 122 and thus is generated using information that cannot be gleaned from the profile information 112 alone. After generating the user experience 106, the user experience system 104 is configured to monitor the user profile(s) 108 for behavior information 110 describing a user's interaction with the user experience 106. This behavior information 110 may be provided as reinforced learning feedback to the respective machine learning models 122 used to generate the user experience 106, thereby re-training the models over time and improving an accuracy of the user experiences generated by the user experience system 104. Having considered operation of the user experience system 104, consider an example machine learning model 122 implemented by the user experience system 104, along with how the example machine learning model 122 is trained on data and how feedback may be provided to the model to improve its accuracy over time.

FIG. 3 illustrates an example implementation 300 of the user experience system 104 employing a machine learning model in a manner that is useable to perform the techniques described herein. The illustrated example is representative of one or more of the machine learning models 122, as illustrated in FIGS. 1 and 2. Specifically, the trained image model 312 is representative of a machine learning model that is useable to compare digital images 304 in an image database 302, based on a similarity criterion 306. Thus, the trained image model 312 is representative of functionality to differentiate various notions of similarity into image features, which may further be encoded into separate dimensions. In operation, the user experience system 104 may employ the trained image model 312 to learn feature masks as the masked feature vectors 308, which are applied over image feature vectors 310 that represent the digital images 304 as generated by the trained image model 312 to induce subspaces which can capture different notions of image similarity. In this manner, the trained image model 312 may be configured as a pre-trained image classification model. Alternatively, as described in further detail below, the user experience system 104 may train the trained image model 312 using the digital images 304 of the image database 302 and feedback, represented in the illustrated example by the similarity criterion 306. Although illustrated in FIG. 3 as a machine learning model that is useable to compare digital images, the machine learning models 122 implemented by the user experience system 104 are not limited to performing image comparisons, and the machine learning models 122 include any model that utilizes algorithms to learn from, and make predictions on, known data by analyzing the known data to learn and generate outputs that reflect patterns and attributes of the known data.

For example, in a learning mode, the user experience system employs the trained image model 312, the feature mask model 314 (e.g., in a learning mode), and the loss function algorithm 316. In implementations, the trained image model 312 (e.g., pre-trained image model) may represent a convolutional neural network. Although described herein with reference to a convolutional neural network, the trained image model 312 is representative of any type of machine learning model 122, such as any machine learning model implemented as a computing algorithm for self-learning with multiple layers that perform logistic regressions on data to learn features and train parameters of the model. The self-learning aspects of a machine learning model 122 may also be referred to as “unsupervised feature learning”, because the input is unknown to the machine learning model (e.g., convolutional neural network), in that the model is not explicitly trained to recognize or classify the image features, but rather trains and learns the image features from the input (e.g., the digital images 304). In the illustrated example 300, the trained image model 312 is a pre-trained convolutional neural network that classifies image features of the digital images 304 in the image database 302. Alternatively, the trained image model 312 may be any type of machine learning model, including but not limited to, decision trees, support vector machines, linear regression, logistic regression, Bayesian networks, random forest learning, dimensionality reduction algorithms, boosting algorithms, neural networks (e.g., fully-connected neural networks, convolutional neural networks, or recurrent neural networks), deep learning networks, and so forth.

When implemented by the user experience system 104, the digital images 304 are each input from the images database 302 to the trained image model 312, such as three example images represented by x1, x2, and x3. For the learning aspect of the illustrated example, the similarity criterion 306 is a known condition, meaning that the similarity criterion in the learning mode is a known, designated input for the particular machine learning model implemented by the user experience system, such as a yes/no type of indication that two compared images are similar, or the two compared images are not similar. Information describing the specific type of known, designated input useable by the trained image model 312 may be represented for a given machine learning model 122 in model metadata 202 provided to the user experience system 104, as illustrated in FIG. 2. In the illustrated example 300, the digital images x1, x2, and x3 may be input to the trained image model 312 along with a condition of the similarity criterion 306, such as a designation of images x1 and x2 being similar and a designation of images x1 and x3 being not similar. In this manner, each possible combination of two or more of the digital images 304 in the image database 302 may be input through the trained image model 312, which then generates output of an image feature vector 310 for each of the digital images x1, x2, and x3.

The image feature vector 310 for a given digital image 304 is a vector representation of the depicted image features in the digital image 304. For instance, the image feature vectors 310 for the corresponding digital images 304 may be represented by the following image vectors: image x1 vector is {1, 5, 4}, image x2 vector is {1, 4, 7}, and image x3 vector is {6, 5, 4}, which represents a simple example of each digital image 304 classified based on three distinguishable image features. For purposes of the illustrated example, the digital images x1, x2, and x3 are input to the trained image model along with specified conditions of the similarity criterion (also referred to as feedback) that the digital images x1 and x2 are not similar, and that images x1 and x3 are similar.

The masked feature vectors 308 for the digital images x1, x2, and x3 are each a feature mask over the respective image feature vectors 310 that indicate the similarities or non-similarities between the digital images. For example, the masked feature vector for the images x1 and x2 may be {1, 0, 0}, which represents that images x1 and x2 are similar, and is multiplied times the image feature vectors 310 for the respective images x1 and x2. Conversely, the masked feature vector for image x3 may be {3, 0, 0}, indicating that the image x3 is not similar to either of the images x1 or x2, or any other one of the digital images 304 having a masked feature vector of {1, 0, 0}. In this manner, the similarity criterion 306 is representative of feedback that can be provided by the user experience system 104 to various ones of the machine learning models 122, which enables generation of a tailored user experience 106 using a wide range of user profile information and behavior information. Although described and illustrated as representing similarity criterion 306, the feedback provided by the user experience system 104 may

Using the feedback represented by similarity criterion 306, the feature mask model 314 may be implemented as a gradient descent type of model to determine masked feature vectors for each of the digital images 304 in the images database 302. Generally, a gradient descent model can be implemented as an optimization algorithm designed to find the minimum of a function, and in the illustrated example implementation 300, optimizes for the loss function algorithm 316. Specifically, the gradient descent algorithm of the feature mask model 314 minimizes a function to determine the masked feature vectors 308 that indicate image features of the digital images 304. In implementations, the feature mask model 314 considers each possible combination pair of digital images 304 by two images at a time.

For example, the feature mask model 314 may be applied to first run the images x1 and x2 based on the similarity criterion 306 input for those two images, determine that they are similar, and generate the appropriate masked feature vector 308. The feature mask model 314 is then applied to run the images x1 and x2 based on the similarity criterion 306 input for those two particular images, determine that they are not similar, and update the generated masked feature vector 308. The feature mask model 314 may then be applied to run the images x2 and x3 based on the similarity criterion 306 input for the image pair, determine that the images x2 and x3 are not similar, and again update the generated masked feature vector 308.

The masked feature vectors 308 for the input digital images x1, x2, and x3 are thus determined by the feature mask model 314 based on the similarity criterion 306. The loss function algorithm 316 may then be applied to maximize the Euclidean distance between the images x1 and x3 (which are not similar as designated by the similarity criterion 306) while minimizing the distance between images x1 and x2 (which are similar as designated by the similarity criterion 306). Given this information, using the illustrated example trained image model 312 as representative of a machine learning model 122 illustrated in FIG. 1, the user experience system 104 may subsequently determine similar images from an uploaded digital image included in profile information 112 to generate a customized user experience 106 that includes the similar digital image(s).

For instance, given a specified user profile 108, the user experience system 104 may identify one or more digital images included in the profile information 112 and run the identified images through the trained image model 312 to identify other digital images included in a data source 124. The digital images may be identified in the profile information 112 based on information describing, for example, digital images specified as favorite on one or more social media platforms by a user corresponding to the user profile 108, digital images included in a photo library of the user, digital images downloaded by the user, and so forth. In an example implementation, behavior information 110 may describe that the user corresponding to user profile 108 has spent the most time viewing a particular image, and a feature vector for the particular image may be input to the trained image model 312, representative of a machine learning model 122 as illustrated in FIG. 1, as the similarity criterion 306. A resulting masked feature vector can thus be utilized to determine the Euclidian distances between the particular image identified by the behavior information 110 and every other digital image 304 in the image database 302, which may be representative of a data source 124, as illustrated in FIG. 1. As illustrated in FIG. 3, the vector space of conditional similarity 318 represents the result of multiplying the image feature vectors 310 with the masked feature vectors 308, which is useable by the user experience system 104 to identify similar images from the data source 124, to be used in generating the user experience 106.

FIG. 4 depicts an example implementation 400 of a user interface for the user experience system 104, which is configured to enable generating a customized user experience using the techniques described herein. In the illustrated example, the user interface 402 is displayed via a display device of the computing device 102 implementing the user experience system 104, such as via an input/output interface, as described in further detail below with respect to FIG. 24. The user interface 402 includes a plurality of controls 404, 406, 408, and 410, which are each selectable via user input to access respective functionality of the user experience system 104. For instance, the user interface 402 may include control 404 that is selectable to select one or more user profiles for which a user experience is to be generated. Control 406 is selectable to select one or more models or target outcomes for use in generating the user experience. Control 408 is selectable to export data generated by the user experience system 104, such as one or more of the first output 204, the translated data, or the second output 208 as illustrated in FIG. 2, to a data source, such as one of the data sources 124 as illustrated in FIG. 1. Control 410 is selectable to save a current state of the user experience system 104's current processing in generating the user experience 106, which enables a user of the computing device implementing the user experience system 104 to stop and subsequently resume generating the user experience 106 in a manner that preserves the user experience system 104's progress in generating the user experience 106.

In the illustrated example of FIG. 4, the user interface 402 may be displayed in response to receiving user input selecting control 404. In some implementations, the control 404 is visually emphasized in a manner that is distinguishable from the other controls 406, 408, and 410 in order to provide subtle guidance to a less-experienced user who may be unfamiliar with generating a user experience 106 using the user experience system 104. In this manner, the shadow displayed at control 404 may visually indicate to a user that the first step in generating the user experience 106 is the selection of one or more user profiles 108 for which the user experience 106 is to be generated. In the illustrated examples of FIGS. 4-21, an example user experience is generated that includes at least one of a specified car type, car make, or car model, customized for a particular set of users using multiple different machine learning models. To facilitate selection of one or more user profiles, the user interface 402 includes a search bar 412, which is configured to receive user input specifying one or more of the user profiles 108 for which the user experience 106 is to be generated.

Alternatively or additionally, the user interface 402 includes a drop-down menu 414, which is selectable to cause display of at least one user profile that is useable by the user experience system 104. In some implementations, the user experience system 104 may display any number of user profiles in response to receiving an indication of user input selecting the drop-down menu 414, such as in a scrollable list below the drop-down menu 414. For instance, in the illustrated example the user interface 402 includes a display of four different user profiles 416, 418, 420, and 422, positioned below the drop-down menu 414. Alternatively or additionally, the different user profiles 416, 418, 420, and 422 may be displayed in response to receiving user input at the search bar 412. The different user profiles 416, 418, 420, and 422 are each representative of one of the user profiles 108, as illustrated in FIG. 1, and thus are each associated with their own profile information and optionally behavior information describing a respective one or more unique users associated with each user profile. As described herein, a user profile may refer to information describing a single user as well as information describing a group of multiple users. For instance, user profile 416 identifies the single user “Hollie A.” and user profile 418 identifies the single user “Rosie A.”, while user profile 420 identifies a group of users characterized as having a loan of greater than $15,000 and user profile 422 identifies a group of users characterized as not having a loan and having good credit scores. In an example scenario, the user profile 422 may be selected as a basis for generating a custom user experience 106 for one or more of the user profiles 108 classified by their profile information 112 as not having a loan and satisfying a threshold credit score to qualify as a good credit risk.

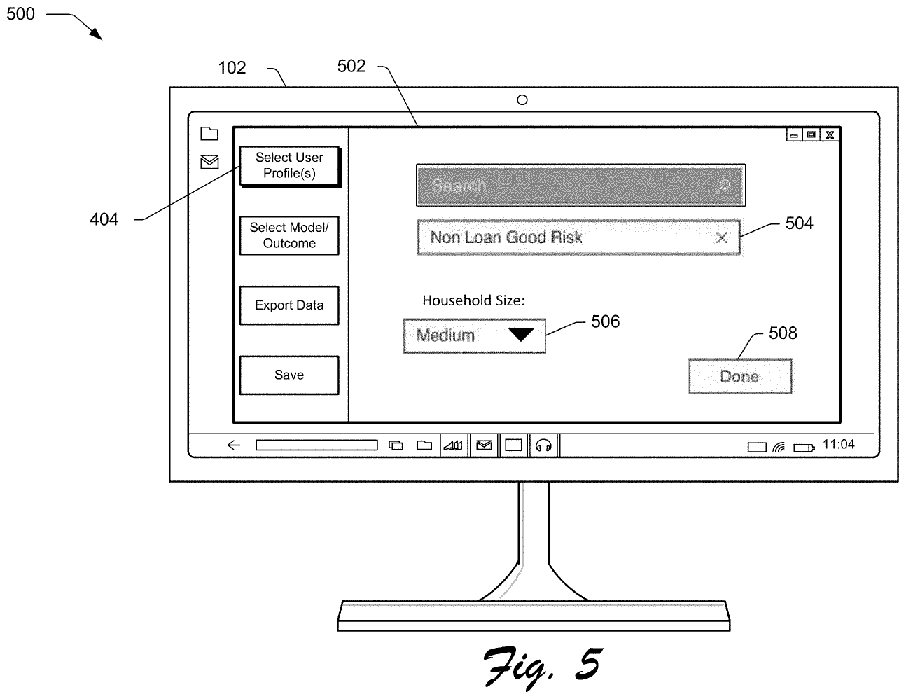

FIG. 5 depicts an example implementation 500 of a user interface displayed by the user experience system 104 in response to receiving user input selecting the user profile 422. In the illustrated example, the user interface 502 displays the control 404 in a visually distinct manner to communicate to a user of the computing device 102 that the user experience system 104 is still selecting one or more user profiles to consider in generating the user experience 106. The user interface 502 visually identifies the selected user profile(s) 504 and optionally one or more options for further refining what user profiles are considered in generating the user experience 106. For instance, the user interface 502 includes an option for further filtering user profiles based on a household size associated with the respective user profile. In the illustrated example, the user experience system 104 further filters a set of user profiles encompassed in the “Non Loan Good Risk” group designated in the selected user profile(s) 504 to include only user profiles associated with a “Medium” household size, as indicated by the dropdown menu 506. For instance, in response to receiving a selection of a “Medium” household size, which may correspond to a household size of 3-5 members, and a selection of the “Done” button 508, the user experience system 104 analyzes the profile information 112 and selects user profiles 108 having information describing a user without a loan, having a threshold credit score, and having a medium household size. In this manner, the user experience system 104 can narrowly target specific groups of users identified by any range of user profile information in order to automatically generate customized user experiences that accurately represent the profile attributes of a given user.

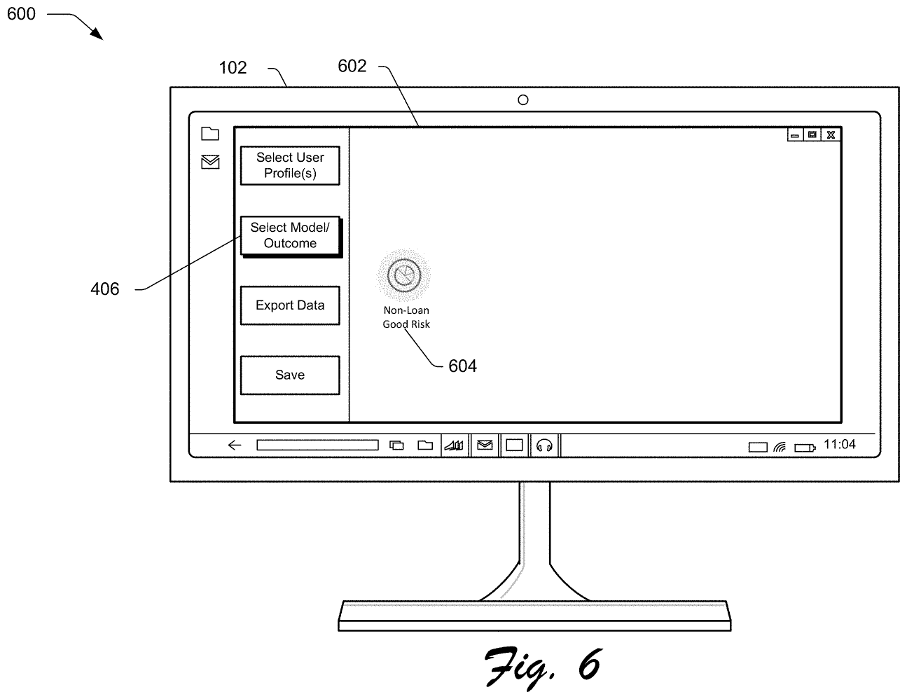

After one or more user profiles have been specified, the user experience system 104 prompts for selection of a machine learning model to be used in generating the user experience 106, such as in the example implementation 600 of FIG. 6. In the illustrated example, the user interface 602 includes an overview of the user experience system 104's current progress in generating the user experience 106. The current progress is represented in the user interface 602 by the icon 604, indicating that the user experience is to be generated for at least one user having profile information indicating that the user does not have a loan and has a credit score satisfying a threshold to qualify the user as a good credit risk. The user interface 602 further includes a display of control 406, which indicates to a user of the user experience system 104 that the next step is the selection of a machine learning model to be used in generating an output useable to generate the custom user experience 106.

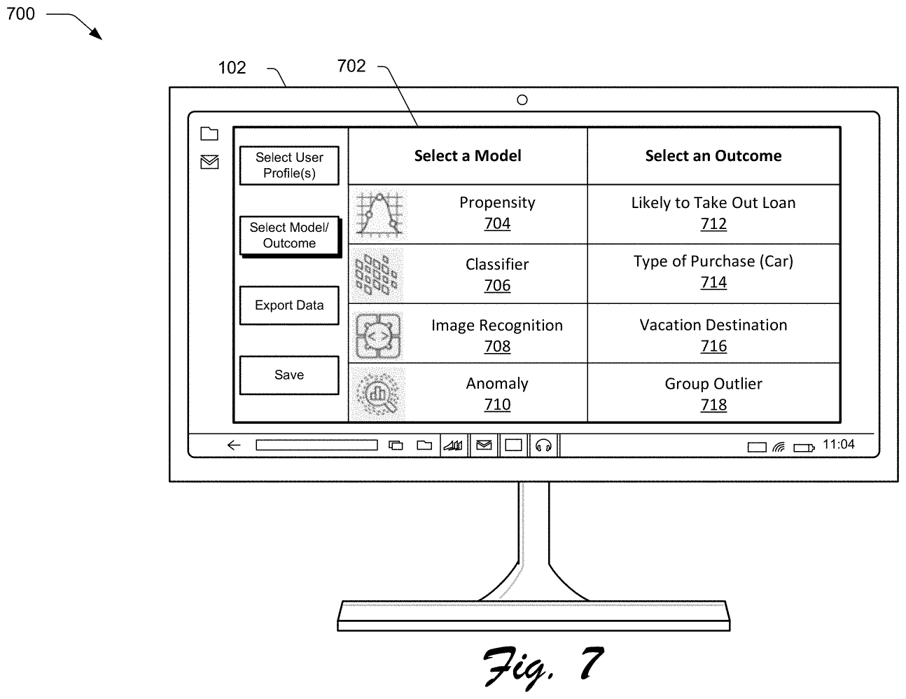

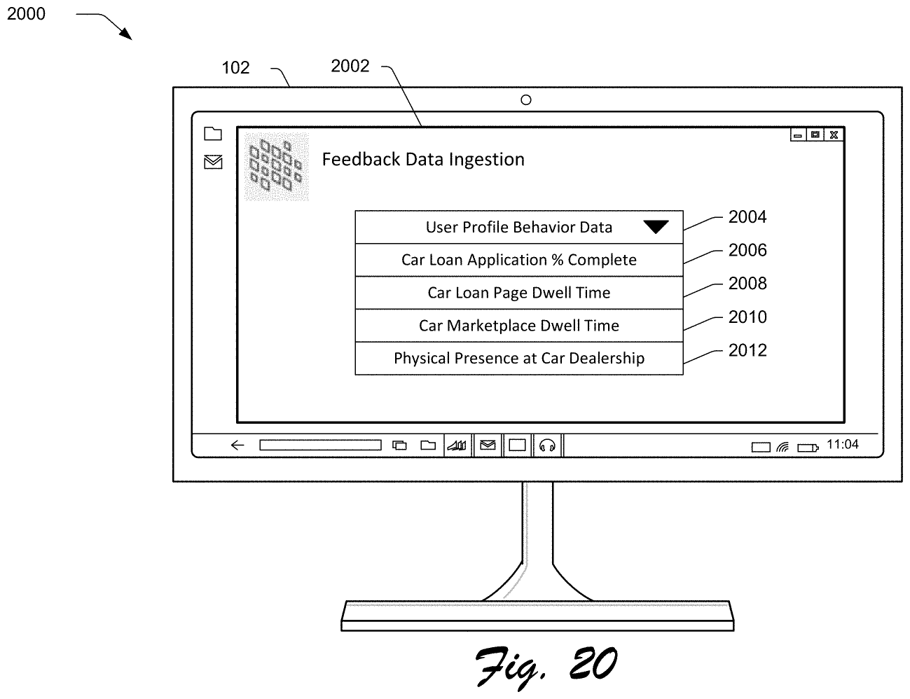

FIG. 7 depicts an example implementation 700 of a user interface displayed by the user experience system 104 in response to receiving user input selecting the control 406. The user interface 702 includes a display of multiple machine learning models, represented by the propensity model 704, the classifier model 706, the image recognition model 708, and the anomaly model 710. The propensity model 704 is representative of one or more of the machine learning models 122 that are useable to predict a behavior of a user of the user profile 108, using the profile information 112 as input, and may broadly represent a predictive analytics model that is useable to anticipate a user's future behavior. In this manner, the behavior information 110 of FIG. 1, describing subsequent behavior for a user profile, can be used as feedback to the propensity model 704 in a manner similar to the similarity criterion 306 of FIG. 3, thereby enabling the user experience system 104 to continuously improve its accuracy in generating user experiences, as described in further detail below with respect to FIG. 20. The classifier model 706 is representative of one or more of the machine learning models 122 that are useable to assign a user profile 108 to one of a specified classification options. For instance, the classifier model 706 may represent a k-nearest neighbor model, a case-based reasoning model, a decision tree model, a naïve Bayes model, an artificial neural network model, and so forth.

The image recognition model 708 is representative of functionality to provide at least one image as an output, provided input such as the profile information 112. For example, the image recognition model 708 is representative of the trained image model 312 illustrated in FIG. 3, which may be configured to output a digital image having features that are identified as similar to aspects of the profile information 112, such as digital images classified as being of a geolocation associated with a home address for one of the user profiles 108. The anomaly model 710 is representative of functionality to identify any outlier in a given dataset that differs significantly from the majority of the data, such as a user profile included in the selected user profiles indicated at 604 in FIG. 6, which may otherwise adversely affect the user experience system 104's ability to accurately generate the user experience 106. Thus, the user interface 702 is configured to display any number of machine learning models 122 that are selectable for use in generating the user experience 106. The display and labeling of the available machine learning models 122 may be performed automatically by the user experience system 104 using information included in the model metadata 202 of the respective machine learning model 122.

Additionally or alternatively, the user interface 702 may include a display of one or more outcomes, represented by the “Likely to Take Out Loan” outcome 712, the “Type of Purchase (Car)” outcome 714, the “Vacation Destination” outcome 716, and the “Group Outlier” outcome 718. Each outcome 712, 714, 716, and 718 is associated with one or more of the machine learning models 122 and describes a type of output that will be generated from applying the respective machine learning model to the selected user profile(s) indicated at 604 in FIG. 6. The specific type of output generated by each of the machine learning models 122 may be specified in the model metadata 202 for the particular machine learning model. In this manner, the user interface 702 clearly describes a type of output to be generated by a given machine learning model when applied to user profile information.

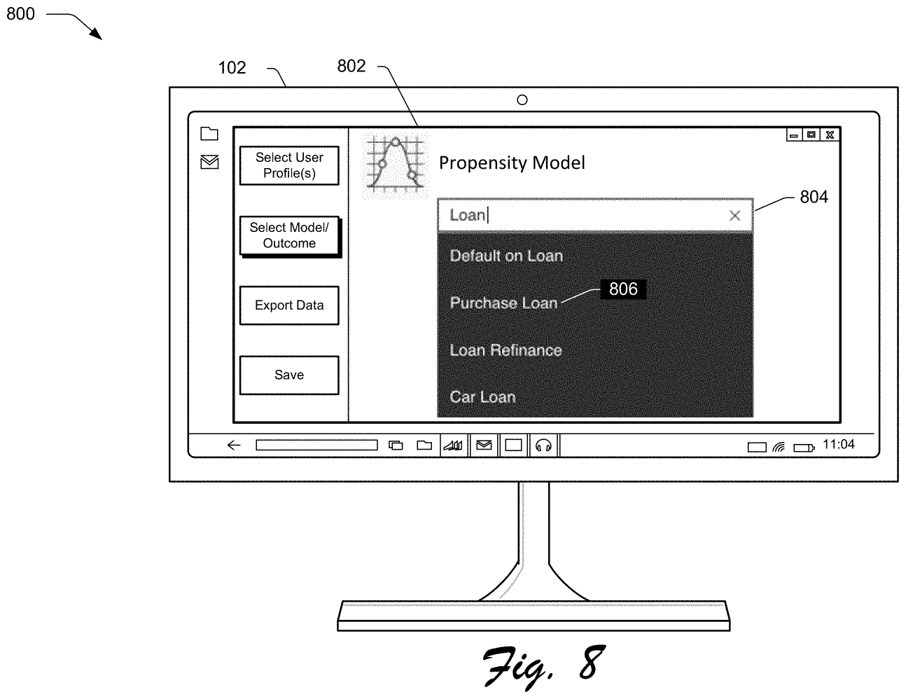

FIG. 8 depicts an example implementation 800 of a user interface displayed by the user experience system 104 in response to receiving user input selecting the propensity model 704. The user interface 802 includes a display of the selected propensity model and additionally includes a search bar 804 that is configured to receive user input searching for a particular type of propensity model. In the illustrated example, the search bar 804 includes a query for a “Loan” propensity model. In response to receiving the query, the user experience system 104 is configured to search the model metadata 202 and identify one or more machine learning models 122 that are described by information in their respective model metadata as being a propensity model and including the keyword “loan”. For example, the user experience system 104 populates the user interface 802 to include four different propensity model options, such as a “Default on Loan” propensity model, a “Purchase Loan” propensity model, a “Loan Refinance” propensity model, and a “Car Loan” propensity model.

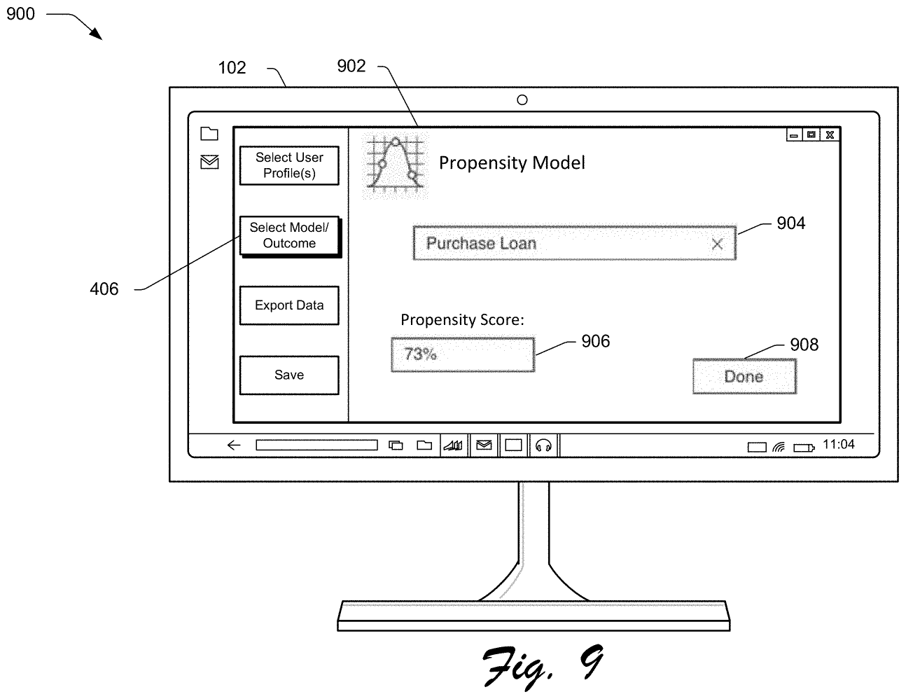

FIG. 9 depicts an example implementation 900 of a user interface displayed by the user experience system 104 in response to receiving a selection of one of the propensity model options displayed in the user interface 802, such as in response to receiving a selection of the “Purchase Loan” propensity model 806. In the illustrated example, the user interface 902 displays the control 406 in a visually distinct manner to communicate to a user of the computing device 102 that the user experience system 104 is still selecting one or more machine learning models 122 to be used in generating the user experience 106. The user interface 902 additionally displays the selected “Purchase Loan” propensity model 904 along with one or more options to specify a tunable parameter of the selected model. For instance, in the user interface 902 includes an option 906 to specify a propensity score for the selected model 904. In the illustrated example, the propensity score represents a tunable parameter of the selected model 904 that affects an output of the selected model 904, such as to generate a predicted behavior for user profiles that are determined to have at least a 73% propensity of purchasing a loan. Although only a single option 906 is included in the illustrated example, the user interface 902 may be configured to include any number of options 906 to further customize a resulting user experience 106 generated by the user experience system 104. The user interface 902 additionally includes a “Done” button 908, which is selectable via user input to inform the user experience system 104 of the selected model 904, and any parameters specified via the option 906, to use in generating the user experience 106.

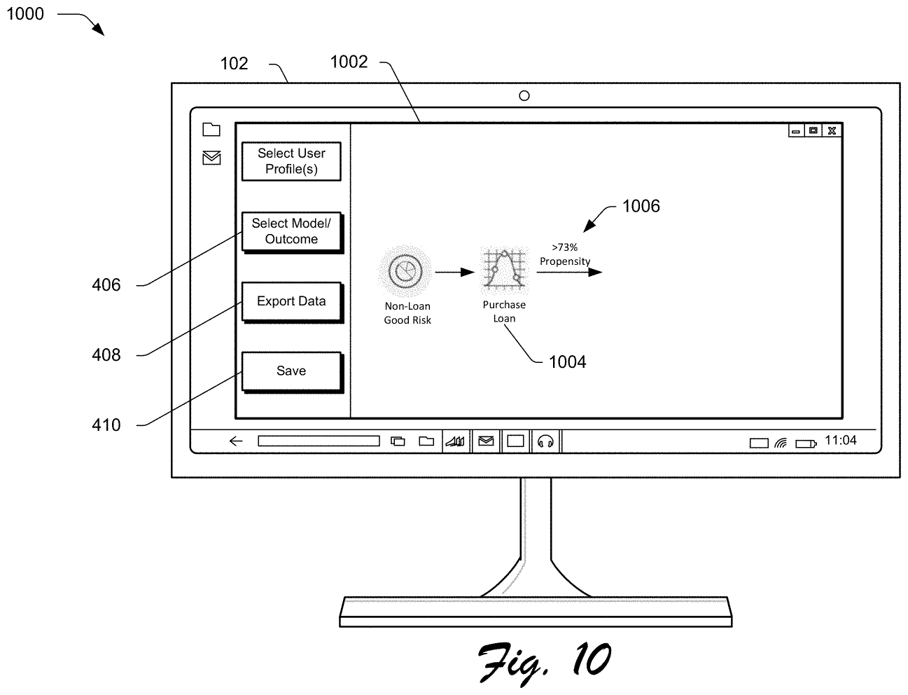

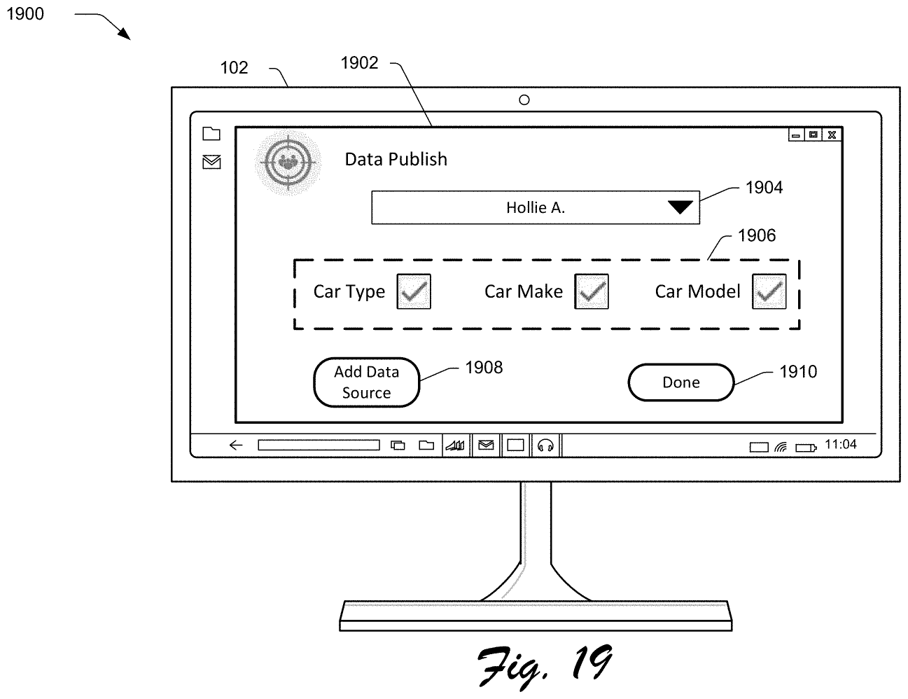

FIG. 10 depicts an example implementation 1000 of a user interface displayed by the user experience system 104 in response to receiving user input selecting the button 908. In the illustrated example, the user interface 1002 includes an overview of the user experience system 104's current progress in generating the user experience 106. The current progress is represented in the user interface 1002, showing additional steps taken by the user experience system 104 since the previous progress displayed in FIG. 6 through the inclusion of the model icon 1004 and the model description 1006. Specifically, the model icon 1004 informs a user of the computing device 1002 that the selected user profiles are to be processed by a purchase loan propensity model to output a predicted behavior for user profiles that are determined to have at least a 73% chance of purchasing a loan. At this point in generating the user experience 106, the user experience system 104 may further process the output generated by the selected purchase loan propensity model using an additional one of the machine learning models 122, may export the data to a storage location, such as to one or more of the user profiles 108 and/or the data sources 124, or may save the current progress of generating the user experience 106 for subsequent completion. To indicate the user experience system's 104 capability to perform any of these actions, the user interface 1002 includes a display of the controls 406, 408, and 410 in a manner that visually emphasizes each control as being selectable to perform its indicated functionality. In response to receiving input selecting the control 408, the user experience system 104 may transition to display a user interface for exporting or publishing the data to one or more locations, as described in further detail below with respect to FIG. 19. In response to receiving input selecting the control 406, the user experience system 104 causes display of the user interface 702, as illustrated in FIG. 7, enabling a user to select an additional model or outcome to further process the first output generated by applying the selected model 904 to the selected user profile(s) indicated by icon 604.

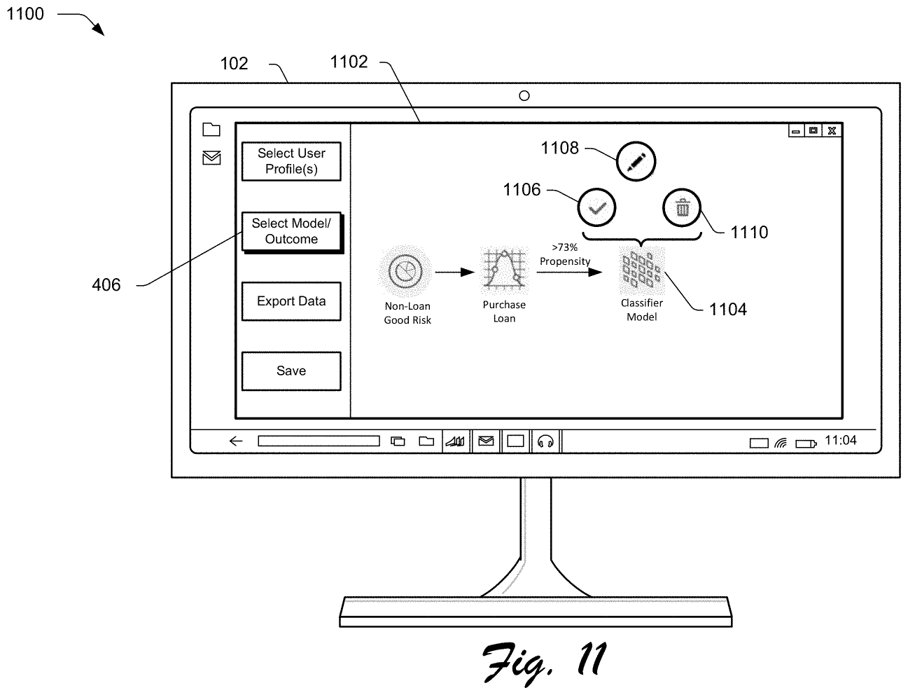

FIG. 11 depicts an example implementation 1100 of a user interface displayed by the user experience system 104 in response to receiving user input selecting an additional one of the models or outcomes included in the user interface 702. In the illustrated example, the user interface 1102 includes a display of a classifier model icon 1104, which corresponds to a user selection of the classifier model 706, as illustrated in FIG. 7. The user interface 1102 additionally includes a display of the control 406 in a manner that is visually emphasized and distinguishable from other aspects of the user interface 1102 to visually indicate to a user that the user experience system 104 is currently selecting a model for use in generating the user experience 106. The user interface 1102 additionally includes model editing controls 1106, 1108, and 1110. Model editing control 1106 enables a user to accept the selected classifier model indicated by the model icon 1104, model editing control 1108 enables a user to modify parameters of the selected model indicated by the model icon 1104, and model editing control 1110 removes the selected model indicated by the model icon 1104. In response to receiving user input selecting the model editing control 1110, the user experience system 104 may revert to display the user interface 702 for subsequent selection of an additional model or outcome to be used in generating the user experience 106.

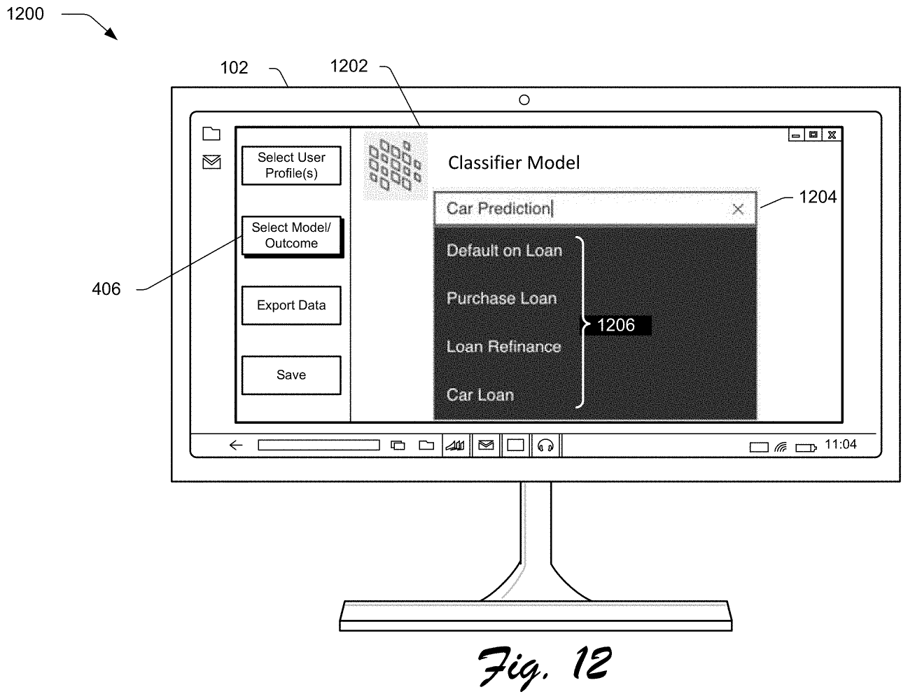

FIG. 12 depicts an example implementation 1200 of a user interface displayed by the user experience system 104 in response to receiving user input selecting the model editing control 1110 included in the user interface 1102. In the illustrated example, the user interface 1202 displays the control 406 in a visually distinct manner to communicate to a user of the computing device 102 that the user experience system 104 is still selecting a model or outcome for use in generating the user experience 106. The user interface 1202 visually identifies the selected classifier model and additionally includes a search bar 1204 that is configured to receive user input searching for a particular type of classifier model. In the illustrated example, the search bar 1204 includes a query for a “Car Prediction” classifier model. In response to receiving the query, the user experience system 104 is configured to search the model metadata 202 and identify one or more machine learning models 122 that are described by information in their respective model metadata as being a classifier model and including the keywords “Car Prediction”. For example, the user experience system 104 populates the user interface 1202 to include various selectable model options 1206 corresponding to the query entered in the search bar 1204. Alternatively or additionally, the user interface 1202 may be populated with available machine learning models corresponding to the model selected in the user interface 1102, such as available classifier models in the illustrated example.

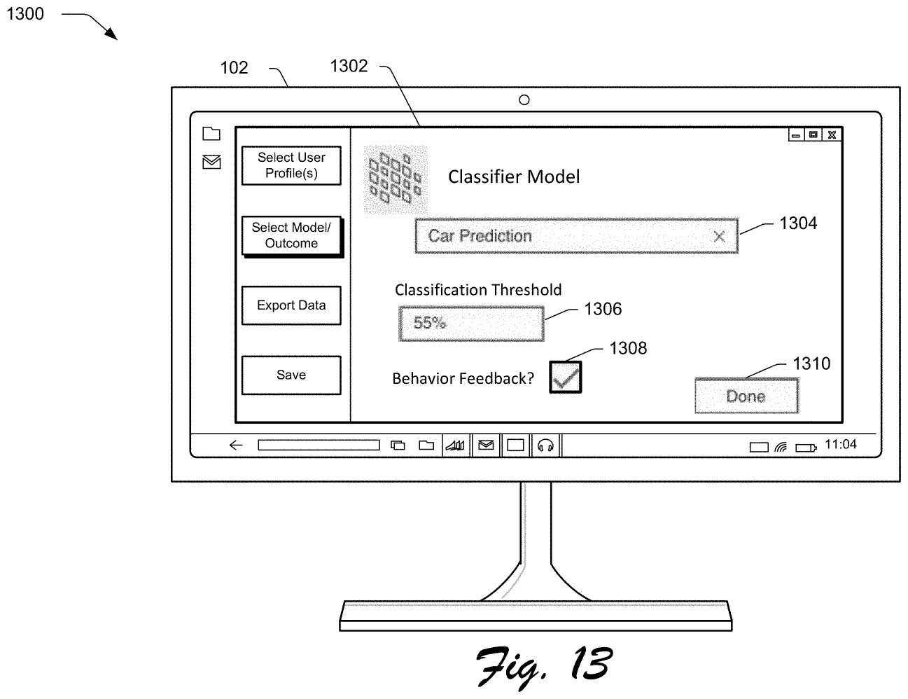

FIG. 13 depicts an example implementation 1300 of a user interface displayed by the user experience system 104 in response to receiving user input selecting one of the classifier models included in the user interface 1202, such as in response to receiving a selection of a “Car Prediction” classifier model. In the illustrated example, the user interface 1302 displays the selected classifier model 1304, along with at least one option to specify a tunable parameter of the selected model. For instance, the user interface 1302 includes an option 1306 to specify a classification threshold for the selected classifier model 1304. In the illustrated example, the classification threshold represents a tunable parameter of the selected classifier model 1304 that affects an output of the classifier model 1304, such as to include only outputs that the classifier model considers to be at least 55% accurate. Although only a single option 1306 is included in the illustrated example, the user interface 1302 may be configured to include any number of options 1306 to further customize a resulting user experience 106 generated by the user experience system 104.

The user interface 1302 additionally includes a selectable radio button 1308, which indicates whether the model should be updated with subsequent behavior information from a user profile for which the user experience 106 is generated. As described herein, this feedback information is useable to improve an accuracy of subsequent outputs generated by the selected classifier model 1304. For instance, in the context of a car prediction classifier model, the output of the model may provide a prediction of a type, make, and model of car that the given user profile(s) are likely to purchase, with at least a 55% confidence. Given this example output, a user experience generated by the user experience system 104 may include an image of the make and model of car identified by the selected classifier model 1304, such as a web page configured to target certain user profiles. Feedback information may then be gleaned from a respective user profile, such as information describing an amount of time that the user profile dwells on the web page including the picture of the make and model of car before navigating to a different web page. In this manner, long dwell times can be associated with positive feedback to the selected classifier model 1304, indicating that the output was accurate, while short dwell times can be associated with negative feedback, indicating that the model's output was inaccurate. In response to receiving selection of the radio button 1308, the user experience system 104 may monitor a corresponding one or more user profiles 108 for behavior information 110 associated with a generated user experience 106 and subsequently apply the behavior information 110 as feedback to the selected classifier model 1304 in a manner similar to the similarity criterion 306, as described with respect to FIG. 3. The user interface 1302 further includes a “Done” button 1310, which is selectable via user input to inform the user experience system 104 of the selected model 1304, and any parameters specified via the option 1306, and whether or not feedback is to be provided to the selected model 1304, for use in generating the user experience 106.

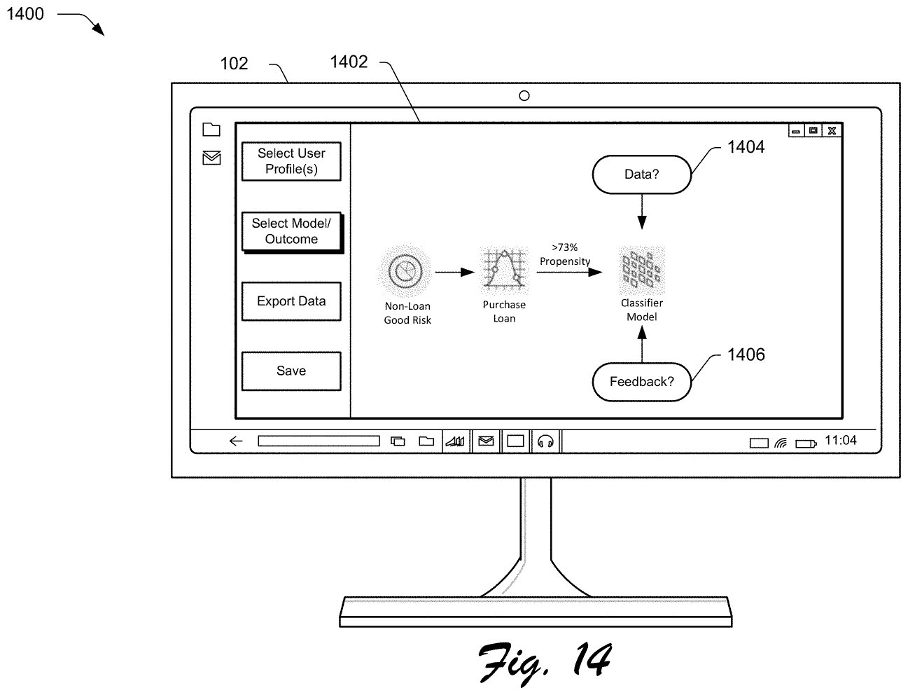

FIG. 14 depicts an example implementation 1400 of a user interface displayed by the user experience system 104 in response to receiving user input selecting the button 1310. In the illustrated example, the user interface 1402 includes an overview of the user experience system 104's current progress in generating the user experience 106. The current progress is represented in the user interface 1402 through the inclusion of the data source button 1404 and the feedback button 1406, in addition to the remaining aspects previously described with respect to FIG. 10. Data source button 1404 enables the user experience system 104 to incorporate information from one or more different data sources, such as the data sources 124 of FIG. 1, for use in generating the user experience 106. For instance, the data source button 1404 may be used to select a third-party data source to use as a basis for training a selected model, such as the selected classifier model 1304 as illustrated in FIG. 13. Inclusion of the data source button 1404 in the user interface 1402 is optional, and may not be included in the user interface 1402 when the selected model has been trained on data with inputs of a similar type to the user profile information 112 corresponding to the selected user profile(s) 108 for which the user experience 106 is being generated. The feedback button 1406 is included in the user interface 1402 in response to the radio button 1308 of FIG. 13 being selected upon receiving user input selecting the button 1310, the functionality of which is described in further detail below with respect to FIG. 20.

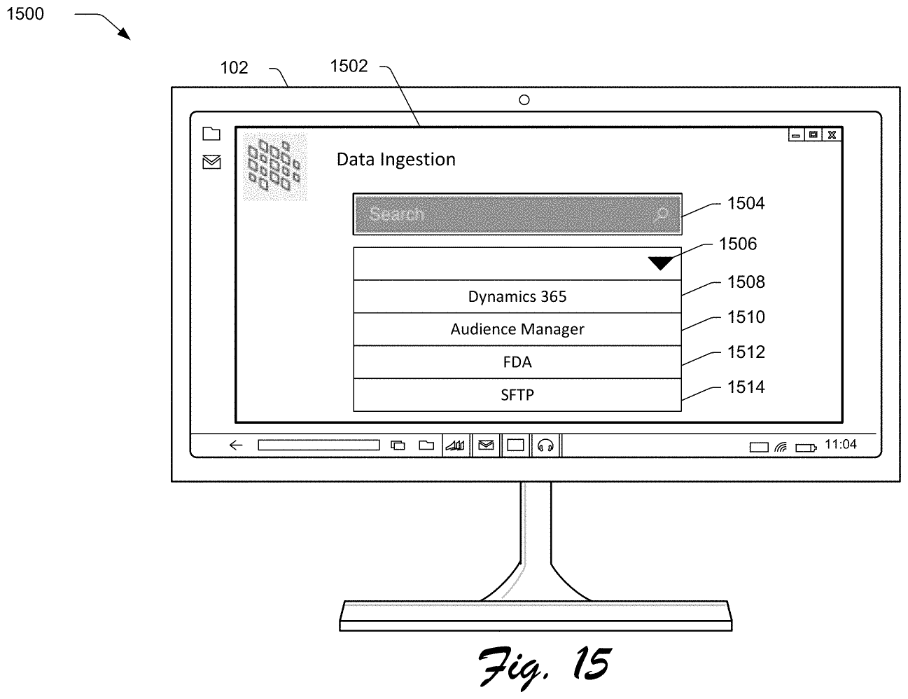

In response to receiving user input selecting the data source button 1404, the user experience system 104 may display the user interface 1502, as illustrated in FIG. 15. In the illustrated example, the user interface 1502 includes a search bar 1504 that is configured to receive a query for a data source, such as one of the data sources 124, from which data is to be imported and applied to a machine learning model selected for use in generating a user experience. Alternatively or additionally, the user interface 1502 may include a drop down menu 1506, which is selectable to cause display of one or more available data sources, such as the “Dynamics 365” data source 1508, the “Audience Manager” data source 1510, the “FDA” data source 1512, and the “SFTP” data source 1514.

In this manner, the user experience system 104 can leverage a range of different machine learning models 122 and data sources 124, and continually improve the performance of the machine learning models by training the models on additional data sets. For instance, in a scenario where profile information 112 includes data describing a user's likes (e.g., beaches, sporting events, etc.) and data describing the user's dislikes (e.g., nightclubs, bars, etc.) and applies a machine learning model 122 that was not trained on inputs describing likes and dislikes, the user experience system 104 may identify a data source 124 including different user profiles with profile information describing respective likes and dislikes of the user profiles and further train the machine learning model 112 using this information such that the retrained model can account for the profile information 112 describing the user's likes and dislikes to generate an accurate output for use in the user experience 106.

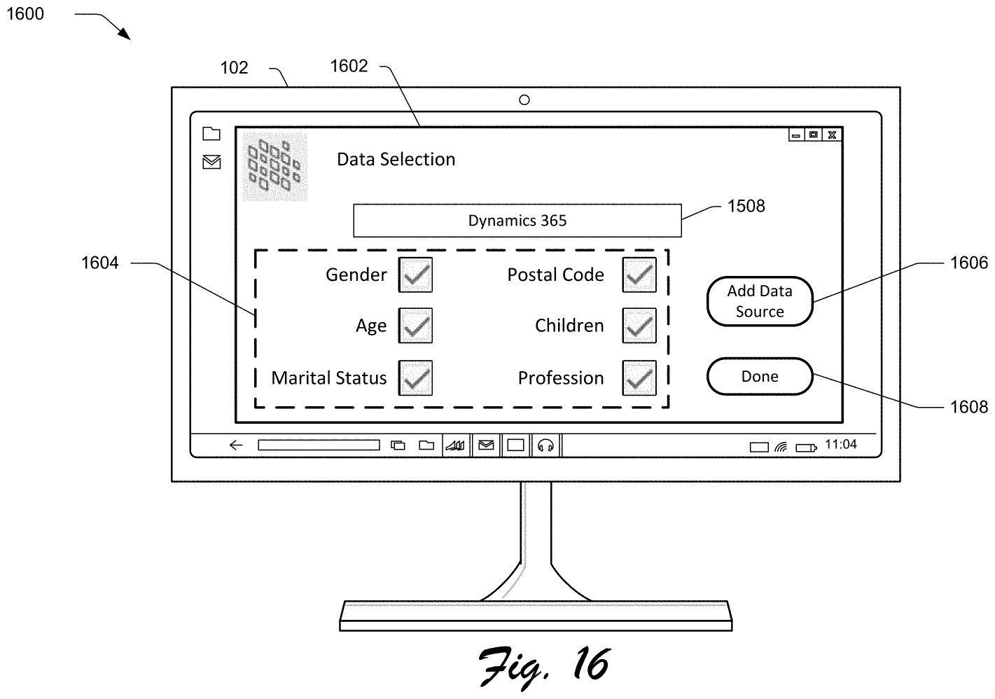

FIG. 16 depicts an example implementation 1600 of a user interface displayed by the user experience system 104 in response to receiving user input selecting one of the available data sources displayed in FIG. 15, such as in response to receiving an indication that the “Dynamics 365” data source 1508 has been selected. In the illustrated example, the user interface 1602 includes a visual indication of the selected “Dynamics 365” data source 1508, along with one or more user profile characteristics 1604 of the selected “Dynamics 365” data source 1508 to be communicated from the corresponding one of the data sources 124 to the user experience system 104. In some implementations, each of the profile characteristics 1604 may correspond to information included in the profile information 112 of the corresponding user profile 108 for which the user experience 106 is generated. The user experience system 104 is optionally configured to bring in data from multiple ones of the data sources 124, as represented by the “Add Data Source” control 1606. In response to receiving user input selecting the “Add Data Source” control 1606, the user experience system 104 may display a user interface similar to the user interface 1502 of FIG. 15, where the displayed data sources are different from the selected “Dynamics 365” data source 1508. In such an implementation, the information displayed by the user interface 1602 may be updated accordingly to reflect that multiple data sources are being selected for ingestion by the user experience system 104. The user interface 1602 additionally includes the “Done” button 1608, which is selectable via user input to indicate to the user experience system 104 that the selected data source and one or more selected profile characteristics 1604 are to be used in generating the user experience 106.

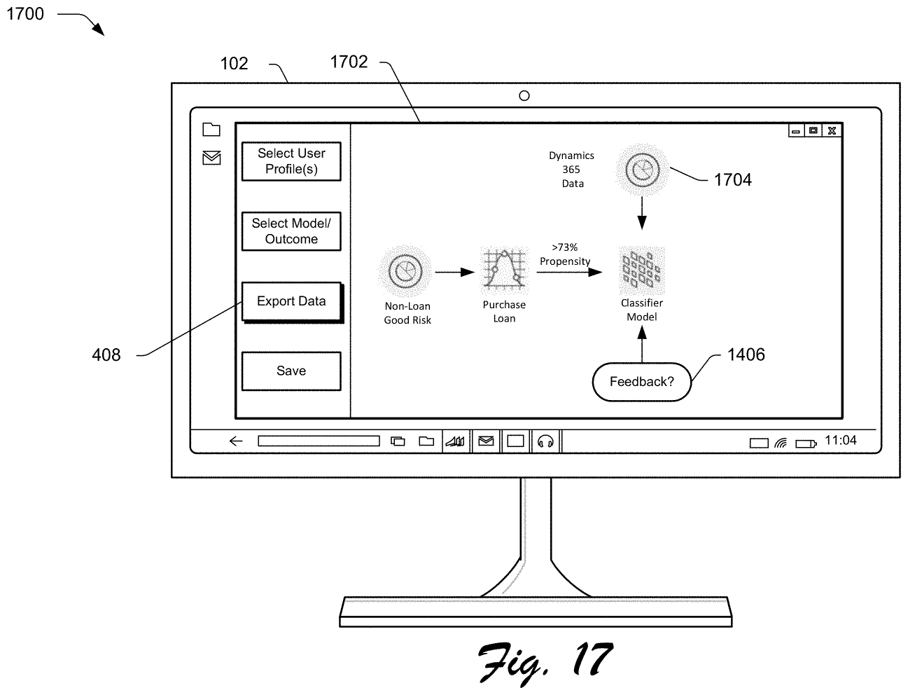

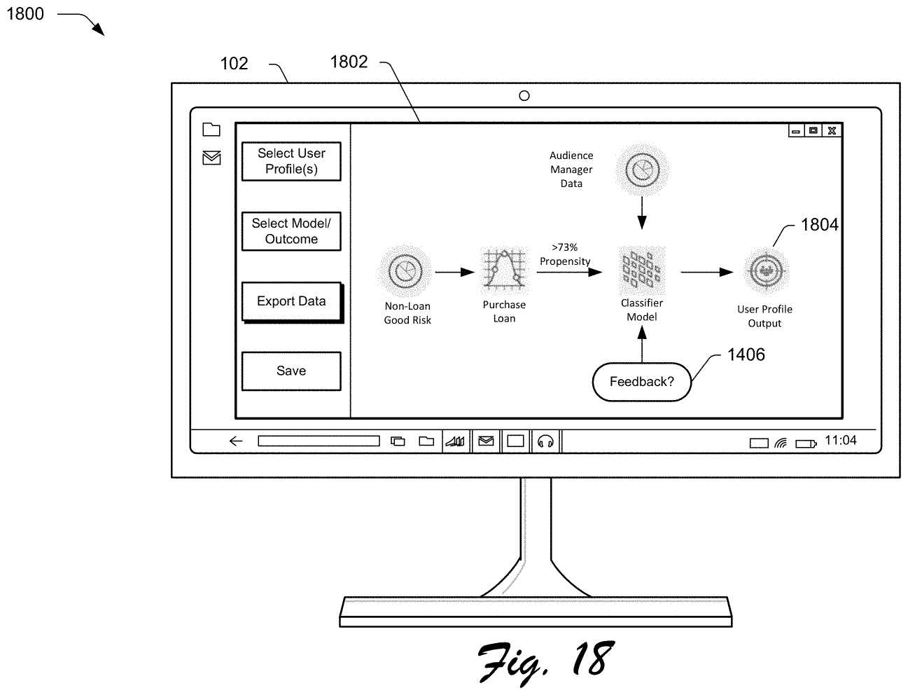

FIG. 17 depicts an example implementation 1700 of a user interface displayed by the user experience system 104 in response to receiving user input selecting the “Done” button 1608. In the illustrated example, the user interface 1702 includes an overview of the user experience system 104's current progress in generating the user experience 106. The current progress is represented in the user interface 1702, showing additional steps taken by the user experience system 104 since the previous progress displayed in FIG. 14. In addition to the display of FIG. 14, the user interface 1702 includes an icon 1704 indicating the selected data source to be used in training the selected classifier model, which is represented as the “Dynamics 365 Data” source. The user interface 1702 additionally includes a display of the control 408 in a manner that is visually emphasized and distinguishable from other portions of the user interface 1702, which indicates to a user of the computing device 102 that the user experience system 104 is ready to generate the user experience 106 by exporting data to one or more of the selected user profiles 108. In response to selecting the control 408, the user experience system 104 may cause display of the user interface 1802, as illustrated in FIG. 18. The user interface 1802 further includes the user profile output icon 1804, which is indicative of information describing at least one piece of content to be included in the user experience 106. Alternatively or additionally, the information describing the at least one piece of content to be included in the user experience 106 can be output to a respective one or more of the user profiles 108 and stored in the profile information 112. In this manner, the user experience system 104 can continuously update the user profiles 108 with information gleaned from generating the user experience 106 to provide more robust user profiles.

FIG. 19 depicts an example implementation 1900 of a user interface displayed by the user experience system 104 in response to receiving user input at the control 408 or at the user profile output icon 1804. In the illustrated example, the user interface 1902 includes a drop-down menu 1904 that may be interacted with via user input to designate at least one user profile for which the information describing at least one piece of content to be included in the user experience 106 is to be output. In some implementations, the drop-down menu 1904 may be populated with the selected user profile(s) for which the user experience 106 is generated. For example, the drop-down menu 1904 may be populated with listings of various user profiles included in the non-loan good risk user profile group indicated in FIG. 6, less any user profiles filtered out through the application of one or more of the machine learning models 122. Thus, in the illustrated example of FIG. 19, the user profile belonging to “Hollie A.” represents one of the unique user profiles included in the non-loan good risk user profile group for which the user experience 106 is generated. Thus, the drop-down menu 1904 may also list a user profile group including multiple unique user profiles for which the generated data is to be exported.

The user interface 1902 additionally includes one or more outputs 1906 that are generated by the selected machine learning models for use in generating the user experience 106, where each selectable output represents information describing different content that can be included in the user experience 106. For instance, in the illustrated example the outputs 1906 include a car type, a car make, and a car model that are likely of interest to the user Hollie A., based on the outputs of one or more of the machine learning models 122 selected in the process of generating the user experience 106. Each of the one or more outputs 1906 may be accompanied by a radio button that is selectable to indicate whether the particular output should be included in the user experience 106, exported to the profile information 112 for the user Hollie A., or exported to a different data source, such as one or more of the data sources 124.

The user interface 1902 further includes an “Add Data Source” button 1908, enabling for the selection of multiple data sources for which the selected outputs are to be published. In some implementations, the drop-down menu 1904 may include a “New User Experience” selection, which enables a user of the computing device 102 to easily specify content defined by the respective outputs 1906 for inclusion in the user experience 106. For instance, in response to receiving a selection of the “Car Make” and “Car Model” outputs 1906, the user experience system 106 may cause an image of a corresponding car make and model identified by the outputs 1906 to be included in, for example, a web page for a bank. In this manner, when the user Hollie A. navigates to the bank's web page, an area of the web page describing the bank's available auto loans may include the image of the particular make and model car, thereby providing a user experience that is particularly tailored to Hollie A. Using the techniques described herein, additional user experiences may be generated for additional users, thereby tailoring user experiences to individual as opposed to creating a single user experience that hopefully appeals to multiple individual users. In response to receiving selection of the “Done” button 1910, the user experience system 104 outputs the user experience 106 and alternatively or additionally outputs information describing the selected ones of the options 1906 to the data source designated in the drop-down menu 1904.

After generating the user experience 106, the user experience system 104 is configured to monitor behavior information with respect to the user experience 106, which may be used to improve the accuracy of one or more of the machine learning models 122 used to generate the user experience. For instance, the user experience system 104 may monitor behavior information 110 pertaining to the user experience 106 in response to receiving a selection of the feedback button 1406.

FIG. 20 depicts an example implementation 2000 of a user interface displayed by the user experience system 104 in response to receiving user input at the feedback button 1406. In the illustrated example, the user interface 2002 includes a drop-down menu 2004 labeled “User Profile Behavior Data”, which is selectable via user input to cause display of one or more types of behavior information 110 that may be monitored by the user experience system 104 and used as feedback to one or more of the machine learning models 122. Alternatively, the one or more types of behavior information 110 to be used as feedback may be manually specified by a user of the computing device implementing the user experience system 104. In some implementations, the types of behavior information 110 included in the drop-down menu 2004 may be selected by the user experience system 104 based on a type of user experience 106 that was generated. Continuing the example scenario where the user experience 106 is generated to include a particular make and model of car that is likely of interest to a user, the types of behavior information options included in the user interface 2002 may include any measurable information pertaining to the user experience. For instance, if the user experience 106 is for a bank's auto loan branch, the behavior information used for feedback may be a percentage completion of a car loan application, indicated by option 2006. A greater percentage completion may identify positive feedback for the generated user experience, while a lower percentage completion may identify negative feedback. Alternatively or additionally, the behavior information used for feedback may be an amount of time spent by a user profile on a car loan web page, indicated by option 2008, or an amount of time spent by a user profile interacting with a car marketplace, indicated by option 2010. Using dwell time as example feedback, greater dwell times may be associated with positive feedback, indicating that the user's attention is caught via the user experience, while lower dwell times may be associated with negative feedback, indicating that the user is disinterested in the user experience. Additionally or alternatively, the behavior information used for feedback may be a user's physical presence at a car dealership, as indicated by option 2012. If a user experience is generated to list a make and model of available cars at a dealership local to a particular user profile 108, data indicating that the user of the particular user profile 108 is physically present at the local dealership may be used as positive feedback to one or more machine learning models used to generate the user experience. In this manner, the user experience system 104 is configured to continually update the machine learning models 122 to improve the accuracy of subsequently generated user experiences 106.

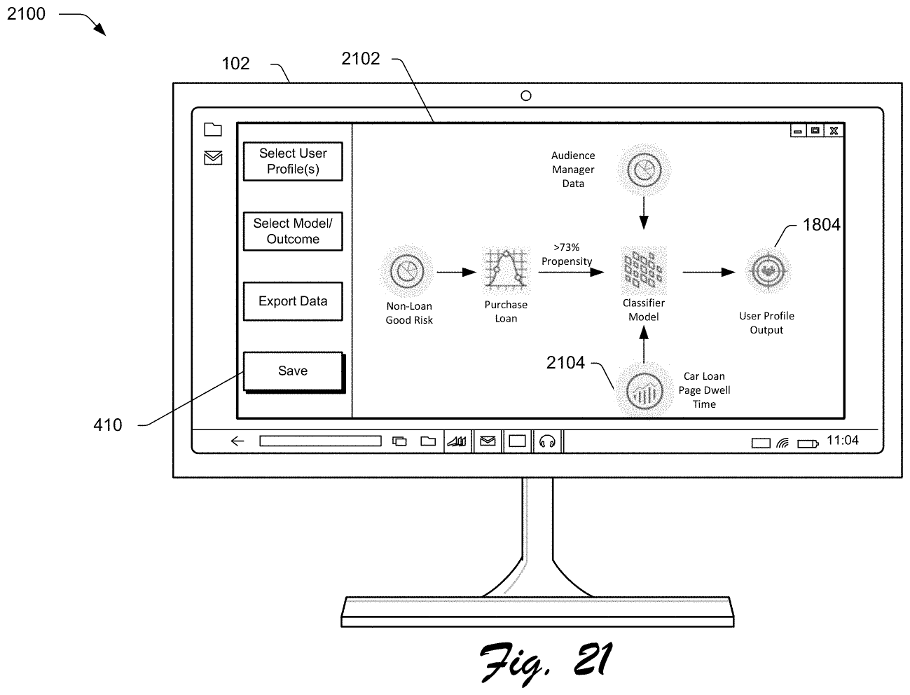

FIG. 21 depicts an example implementation 2100 of a user interface displayed by the user experience system 104 in response to receiving input designating one or more types of behavior information to be used as feedback for one or more machine learning models. In the illustrated example, the user interface 2102 includes a display of the user experience system 104's overall progress in generating the user experience, represented by the user profile output 1804. The user interface 2102 further includes the feedback icon 2104, indicating that an amount of time spent by a user profile on a car loan page is to be used as feedback for at least one of the machine learning models 122 selected for use in generating the user experience 106. The user interface 2102 additionally includes the “Save” control 410 displayed in a visually emphasized manner to indicate that the overall workflow for generating the user experience can be saved for subsequent access and editing. In this manner, the workflow can be accessed later to generate a new user experience for a different user profile without requiring the entire workflow to be started from scratch.

Having discussed example details of the techniques for generating customized user experiences, consider now some example procedures to illustrate additional aspects of the techniques.

Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to FIGS. 1-21.

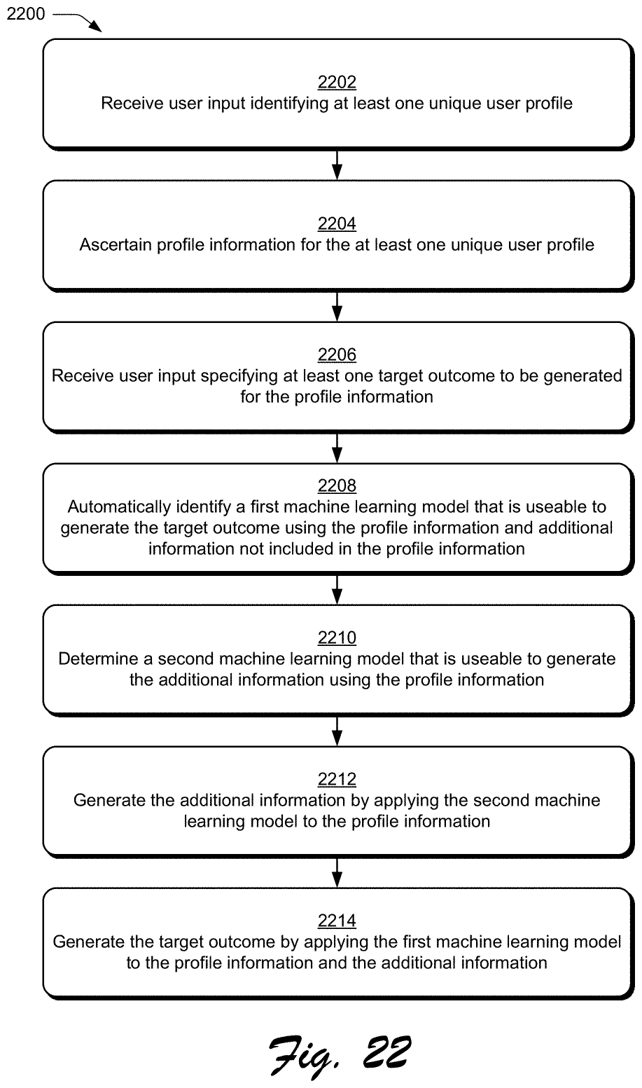

FIG. 22 depicts a procedure 2200 in an example implementation of user experience generation using the techniques describe herein. User input identifying at least one unique user profile is received (block 2202). The computing device implementing the user experience system 104, for instance, receives user input specifying at least one of the user profiles 108 for which the user experience 106 is to be generated.

In response to receiving the user input selecting the at least one unique user profile, user profile information is ascertained for the at least one unique user profile (block 2204). The user experience system 104, for instance, ascertains profile information 112 for each selected user profile 108. User input is then received, specifying at least one target outcome to be generated for the profile information (block 2206). The user experience system 104, for instance, receives user input selecting one of the target outcomes 712, 714, 716, or 718, as illustrated in FIG. 7.

In response to receiving the user input specifying the at least one target outcome to be generated, a first machine learning model that is useable to generate the target outcome using the profile information and additional information not included in the profile information is identified (block 2208). The outcome selection module 114, for instance, identifies one of the machine learning models 122 that is useable to generate the target outcome using the profile information 112 for the at least one selected user profile 108 and additional information that is not included in the profile information 112.

A second machine learning model that is useable to generate the additional information using the profile information is then determined (block 2210). The outcome selection module 114, for instance, identifies a different one of the machine learning models 122 that is useable to generate the additional information using the profile information 112. After identifying the second machine learning model, the additional information is generated by applying the second machine learning model to the profile information (block 2212). The outcome selection module 114, for instance, applies the profile information 112 as input to the different one of the machine learning models 122. Optionally, the data translation module 116 first translates data included in the profile information 112 to a format that is useable by the different one of the machine learning models 122 prior to applying the profile information 112 to the different one of the machine learning models.

The target outcome is then generated by applying the profile information and the additional information as input to the first machine learning module (block 2214). The outcome selection module 114, for instance, applies the first machine learning model 122, using the profile information 112 and the additional information generated by the second machine learning model 122 as inputs for the first machine learning model.

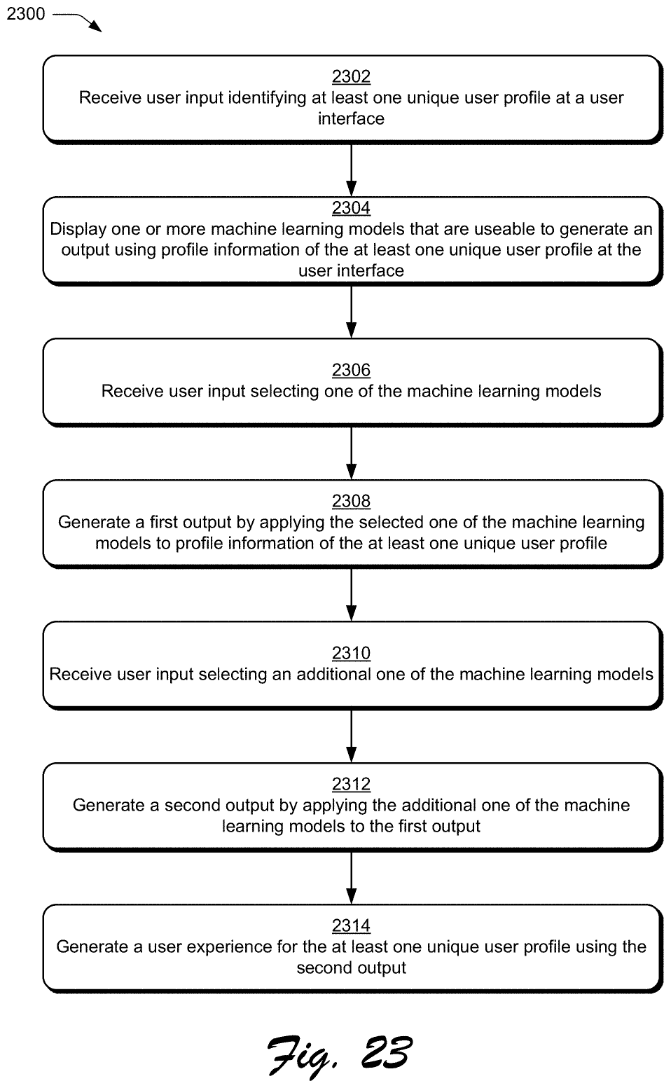

FIG. 23 depicts a procedure 2300 in an example implementation of generating a custom user experience for at least one user profile using multiple machine learning models using the techniques described herein. User input identifying at least one unique user profile is received at a user interface (block 2302). The computing device implementing the user experience system 104, for instance, receives user input specifying at least one of the user profiles 108 for which the user experience 106 is to be generated.

In response to receiving the user input selecting the at least one unique user profile, one or more machine learning models that are useable to generate an output using profile information of the at least one user profile are displayed at the user interface (block 2304). The outcome selection module 114, for instance, identifies one or more machine learning models 122 that are useable to generate an outcome based on profile information 112 of the at least one user profile 108 for which the user experience 106 is to be generated. For example, the outcome selection module 114 may display at the user interface the propensity model 704, the classifier model 706, the image recognition model 708, and anomaly model 710, as illustrated in FIG. 7.

User input is then received selecting one of the displayed machine learning models (block 2306). The outcome selection module 114, for instance, receives user input selecting the propensity model 704, as indicated by the resulting user interface 802, illustrated in FIG. 8. In response to receiving the user input selecting the machine learning model, a first output is generated by applying the selected machine learning model to profile information of the at least one unique user profile (block 2308). The outcome selection module 114, for instance, generates the first output 204 by applying the profile information 112 as input to a selected one of the machine learning models 122.

After generating the first output, user input selecting an additional one of the machine learning models is received (block 2310). The outcome selection module 114, for instance, receives user input selecting one of the classifier model 706, the image recognition model 708, and anomaly model 710, as illustrated in FIG. 7. Responsive to receiving user input selecting the additional one of the machine learning models, a second output is generated by applying the first output as input to the additional one of the machine learning models (block 2312). The data translation module 116, for instance, optionally translates the first output 204 to generate translated data 206 that includes data of a type and format suitable for input to an additional one of the machine learning models 122. The outcome selection module 114 may then apply the translated data 206 to the additional one of the machine learning models, such as one of the classifier model 706, the image recognition model 708, and anomaly model 710, to generate the second output 208.

In response to generating the second output, a user experience for the at least one unique user profile is generated using the second output (block 2314). The experience generation module 118, for instance, generates the user experience for the selected one or more of the user profiles 108 using the second output 208.

Having described example procedures in accordance with one or more implementations, consider now an example system and device that can be utilized to implement the various techniques described herein.

Example System and Device

FIG. 24 illustrates an example system generally at 2400 that includes an example computing device 2402 that is representative of one or more computing systems and/or devices that may implement the various techniques described herein. This is illustrated through inclusion of the user experience system 104. The computing device 2402 may be, for example, a server of a service provider, a device associated with a client (e.g., a client device), an on-chip system, and/or any other suitable computing device or computing system.

The example computing device 2402 as illustrated includes a processing system 2404, one or more computer-readable media 2406, and one or more I/O interface 2408 that are communicatively coupled, one to another. Although not shown, the computing device 2402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2404 is representative of functionality to perform one or more operations using hardware. Accordingly, the processing system 2404 is illustrated as including hardware element 2410 that may be configured as processors, functional blocks, and so forth. This may include implementation in hardware as an application specific integrated circuit or other logic device formed using one or more semiconductors. The hardware elements 2410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2406 is illustrated as including memory/storage 2412. The memory/storage 2412 represents memory/storage capacity associated with one or more computer-readable media. The memory/storage component 2412 may include volatile media (such as random access memory (RAM)) and/or nonvolatile media (such as read only memory (ROM), Flash memory, optical disks, magnetic disks, and so forth). The memory/storage component 2412 may include fixed media (e.g., RAM, ROM, a fixed hard drive, and so on) as well as removable media (e.g., Flash memory, a removable hard drive, an optical disc, and so forth). The computer-readable media 2406 may be configured in a variety of other ways as further described below.

Input/output interface(s) 2408 are representative of functionality to allow a user to enter commands and information to computing device 2402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2410 and computer-readable media 2406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2410. The computing device 2402 may be configured to implement particular instructions and/or functions corresponding to the software and/or hardware modules. Accordingly, implementation of a module that is executable by the computing device 2402 as software may be achieved at least partially in hardware, e.g., through use of computer-readable storage media and/or hardware elements 2410 of the processing system 2404. The instructions and/or functions may be executable/operable by one or more articles of manufacture (for example, one or more computing devices 2402 and/or processing systems 2404) to implement techniques, modules, and examples described herein.

The techniques described herein may be supported by various configurations of the computing device 2402 and are not limited to the specific examples of the techniques described herein. This functionality may also be implemented all or in part through use of a distributed system, such as over a “cloud” 2414 via a platform 2416 as described below.

The cloud 2414 includes and/or is representative of a platform 2416 for resources 2418. The platform 2416 abstracts underlying functionality of hardware (e.g., servers) and software resources of the cloud 2414. The resources 2418 may include applications and/or data that can be utilized while computer processing is executed on servers that are remote from the computing device 2402. Resources 2418 can also include services provided over the Internet and/or through a subscriber network, such as a cellular or Wi-Fi network.

The platform 2416 may abstract resources and functions to connect the computing device 2402 with other computing devices. The platform 2416 may also serve to abstract scaling of resources to provide a corresponding level of scale to encountered demand for the resources 2418 that are implemented via the platform 2416. Accordingly, in an interconnected device embodiment, implementation of functionality described herein may be distributed throughout the system 2400. For example, the functionality may be implemented in part on the computing device 2402 as well as via the platform 2416 that abstracts the functionality of the cloud 2414.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method for combining different machine learning models for processing user behavior information, the method comprising:
receiving, at a user interface of a computing device, user input identifying at least one unique user profile;
ascertaining, by the computing device, profile information associated with the at least one unique user profile;
automatically identifying, by the computing device, a first machine learning model that is useable to generate an output using the profile information and additional information not described by the profile information;
determining, by the computing device, a second machine learning model that is useable to generate the additional information using the profile information;
applying, by the computing device, the second machine learning model to the profile information to generate the additional information; and
generating, by the computing device, the output by applying the first machine learning model to the profile information and the additional information.

2. The computer-implemented method recited in claim 1, wherein the unique user profile comprises information describing a user's activity at a single computing device or across a group of two or more computing devices.

3. The computer-implemented method as recited in claim 1, further comprising receiving, at the user interface, user input specifying at least one target outcome to be generated for the profile information and the behavior information.

4. The computer-implemented method as recited in claim 1, wherein the output includes information describing digital content that is likely of interest to the at least one unique user profile, the digital content comprising at least one of an image, a video, text, or audio.

5. The computer-implemented method as recited in claim 1, further comprising generating a user experience that includes the digital content corresponding to information described by the target outcome.

6. The computer-implemented method as recited in claim 1, further comprising displaying, at the user interface, at least one target outcome and receiving a selection of one of the at least one target outcome, wherein automatically identifying the first machine learning model is performed based on the selected target outcome.

7. A system comprising:
at least one processor; and
one or more computer-readable storage media having instructions stored thereon that are executable by the at least one processor to perform operations comprising:
receiving, via a user interface displayed at a computing device, user input identifying at least one user profile for which a user experience is to be generated;
determining user profile information corresponding to the at least one user profile and displaying, at the user interface, one or more machine learning models that are each useable to generate an output using the user profile information;
receiving a selection of one of the one or more machine learning models via the user interface;
generating a first output by applying at least a subset of the user profile information to the one of the one or more machine learning models;
displaying, at the user interface, one or more additional machine learning models that are each useable to generate an output using the first output and receiving a selection of one of the one or more additional machine learning models;
generating a second output by applying the first output to the one of the selected one or more additional machine learning models;
generating the user experience based on the second output.

8. The system as described in claim 7, the operations further comprising identifying the one or more machine learning models based on model metadata describing an input data type, an input data format, an output data type, and an output data format for each of the one or more machine learning models.

9. The system as described in claim 7, the operations further comprising displaying, at the user interface, at least one tunable parameter for the selected one of the one or more machine learning models and receiving user input specifying a value for the at least one tunable parameter, wherein the generating the first output is performed using the value for the at least one tunable parameter.

10. The system as described in claim 7, wherein the at least one user profile comprises a user profile associated with a unique individual user.

11. The system as described in claim 7, wherein the at least one user profile comprises a group of multiple user profiles sharing at least one common profile characteristic.

12. The system as described in claim 7, the operations further comprising determining that the first output includes data formatted differently than an input data format acceptable by the one of the one or more additional machine learning models and translating the first output to the input data format prior to generating the second output.

13. The system as described in claim 7, the operations further comprising monitoring behavior information of the at least one user profile describing an interaction with the user experience and re-training the one of the one or more machine learning models or the one of the one or more additional machine learning models using the behavior information.

14. The system as described in claim 13, wherein the behavior information comprises an amount of time spent interacting with the user experience.

15. The system as described in claim 13, wherein the behavior information comprises an indication of whether a purchase was made after viewing the user experience.

16. A system comprising:
means for generating a first output by applying user profile information for at least one user profile as input to a first machine learning model;
means for translating the first output to a data format configured for input to a second machine learning model that is different from the first machine learning model;
means for generating a second output by applying the translated first output to the second machine learning model;
means for identifying digital content based on information included in the second output;
means for generating a user experience that includes the digital content;
means for monitoring behavior information describing an interaction by the at least one user profile with the user experience; and
means for improving an output performance of at least one of the first machine learning model or the second machine learning model by providing the behavior information as feedback to the at least one of the first machine learning model or the second machine learning model.

17. The computer-implemented method as recited in claim 16, wherein the first machine learning model and the second machine learning model each include model metadata describing an input data type, an input data format, an output data type, and an output data format for the machine learning model.

18. The computer-implemented method as recited in claim 16, the behavior information comprising an amount of time spent interacting with the user experience.

19. The computer-implemented method as recited in claim 16, the behavior information comprising an indication of whether a purchase was made after viewing the user experience.

20. The computer-implemented method as recited in claim 16, wherein the at least one user profile comprises a user profile associated with a unique individual user or a group of multiple user profiles sharing at least one common profile characteristic.
